(19) United States
(12) Patent Application Publication
(10) Pub. No.: US 2020/0059813 A1
(43) Pub. Date: Feb. 20, 2020

(54) V2X PACKET PRIORITIZATION AND CONTROL TECHNIQUES

(71) Applicant: QUALCOMM Incorporated, San Diego, CA (US)

(72) Inventors: Hee Jun PARK, San Diego, CA (US); Cheol Hee PARK, San Diego, CA (US)

(21) Appl. No.: 16/526,732

(22) Filed: Jul. 30, 2019

Related U.S. Application Data
(60) Provisional application No. 62/719,527, filed on Aug. 17, 2018.

(51) Int. Cl. H04W 28/02; H04W 4/46

(52) U.S. Cl. CPC H04W 28/021; H04W 84/005; H04W 28/0221; H04W 4/46

(57) ABSTRACT

Aspects of the disclosure relate to mechanisms for a vehicle-to-everything (V2X) device to prioritize communication from other nearby V2X devices and to selectively process packets from the other nearby V2X devices based on the assigned priorities. The V2X device may measure one or more performance factors of the V2X device, and select one or more other nearby V2X devices to receive and process packets therefrom based on the performance factors and the priorities assigned to the other V2X devices. The V2X device may then ignore any packets received from non-selected V2X devices to reduce and/or control the receive packet flow rate. The performance factors may further be utilized to control one or more transmission characteristics, such as the transmit power and transmit packet flow rate.

### PRIORITY CLAIM

This application claims priority to and the benefit of Provisional Patent Application No. 62/719,527, entitled “C-V2X Packet Prioritization and Control to Meet Performance and Thermal Power Limits,” filed in the U.S. Patent and Trademark Office on Aug. 17, 2018, the entire contents of which are incorporated herein by reference as if fully set forth below in their entirety and for all applicable purposes.

### TECHNICAL FIELD

The technology discussed below relates generally to wireless communication networks, and more particularly, to vehicle-to-everything (V2X) wireless communication.

### INTRODUCTION

Vehicle-to-Everything (V2X) communication involves the wireless exchange of information between not only vehicles themselves, but also between vehicles and external systems, such as streetlights, buildings, pedestrians, and wireless communication networks. V2X systems enable vehicles to obtain information related to the weather, nearby accidents, road conditions, activities of nearby vehicles and pedestrians, objects nearby the vehicle, and other pertinent information that may be utilized to improve the vehicle driving experience and increase vehicle safety.

Two primary technologies that may be used by V2X networks include dedicated short-range communication (DSRC) based on IEEE 802.11p standards and cellular V2X (C-V2X) based on Long Term Evolution (LTE) and/or 5G (New Radio) standards. C-V2X is designed to be compatible with both 4G LTE and emerging New Radio (NR) technologies, enabling C-V2X devices to support both C-V2X connections and LTE and/or NR connections.

As the demand for V2X communication increases, research and development continue to advance V2X technologies not only to meet the growing demand for V2X, but also to advance and enhance the V2X performance capability.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Various aspects of the disclosure relate to mechanisms for a vehicle-to-everything (V2X) device to prioritize communication from other nearby V2X devices and to selectively process packets from the other nearby V2X devices based on the assigned priorities. In some aspects of the disclosure, the V2X device may measure one or more performance factors related to, for example, a die temperature, processor utilization percentage, throughput, and/or power consumption of the V2X device, and select one or more nearby V2X devices to receive and process packets therefrom based on the performance factor(s) and the priorities assigned to the nearby V2X devices.

In some examples, the V2X device may maintain a first list of the other nearby V2X devices and determine a number of the nearby V2X devices to include in a second list based on the performance factors. The V2X device may then select up to the number of nearby V2X devices for inclusion in the second list based on the priorities assigned to the nearby V2X devices, such that the selected V2X devices included in the second list have higher respective priorities than the non-selected V2X devices not included in (omitted from) the second list. The V2X device may then ignore any packets received from non-selected V2X devices omitted from the second list (e.g., the V2X devices included in only the first list) to reduce and/or control a receive packet flow rate.

In addition, the V2X device may further utilize the performance factor(s) to control one or more transmission characteristics, such as the transmit power, transmit packet flow rate, type of packets allowed to be transmitted, and/or the modulation and coding scheme (MCS) and number of resource blocks assigned to transmit packets. The packet prioritization and transmit/receive packet control mechanisms described herein may, in certain instances, enable the V2X device to possibly improve performance, affect thermal power aspects, and/or the like in traffic processing.

In one example, a method for vehicle-to-everything (V2X) wireless communication at a first V2X device is disclosed. The method includes establishing a set of one or more nearby V2X devices capable of V2X communication with the first V2X device, assigning a respective priority to each of the one or more nearby V2X devices, identifying a subset of the set based, at least in part, on the assigned respective priorities and at least one performance factor of the first device, and limiting processing of packets received from the one or more nearby V2X devices to the packets received from the one or more nearby V2X devices in the subset.

Another example provides a first vehicle-to-everything (V2X) device for V2X wireless communication. The first V2X device includes a transceiver, a memory, and a processor communicatively coupled to the transceiver and the memory. The processor is configured to establish a set of one or more nearby V2X devices capable of V2X communication with the first V2X device, assign a respective priority to each of the one or more nearby V2X devices, identifying a subset of the set based, at least in part, on the assigned respective priorities and at least one performance factor of the first device, and limit processing of packets received from the one or more nearby V2X devices to the packets received from the one or more nearby V2X devices in the subset.

Another example provides a first vehicle-to-everything (V2X) device for V2X wireless communication. The first V2X device includes means for establishing a set of one or more nearby V2X devices capable of V2X communication with the first V2X device, means for assigning a respective priority to each of the one or more nearby V2X devices, means for identifying a subset of the set based, at least in part, on the assigned respective priorities and at least one performance factor of the first device, and means for limiting processing of packets received from the one or more nearby V2X devices to the packets received from the one or more nearby V2X devices in the subset.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of a wireless radio access network.

FIG. 2 is a diagram illustrating an example of a vehicle-to-everything (V2X) wireless communication network.

FIG. 3 is a schematic diagram illustrating organization of wireless resources in an air interface utilizing orthogonal frequency divisional multiplexing (OFDM).

FIG. 4 is a graph illustrating examples of the thermal power envelope and power consumption of modem system on chips (SoCs) with different leakage currents;

FIG. 5 is a diagram illustrating examples of the performance capability of a modem supporting 4G, 5G and V2X workloads.

FIG. 6 is a block diagram illustrating an example of a V2X controller according to some aspects of the present disclosure.

FIG. 7 is a block diagram illustrating an example of a hardware implementation for a V2X device employing a processing system according to some aspects of the present disclosure.

FIG. 8 is a diagram illustrating exemplary priority criteria that may be utilized to assign a priority to a V2X device according to some aspects of the present disclosure.

FIG. 9 is a diagram illustrating an exemplary list of nearby V2X devices according to some aspects of the present disclosure.

FIG. 10 is a flow chart of an exemplary method for V2X wireless communication at V2X device according to some aspects of the present disclosure.

FIG. 11 is a flow chart of another exemplary method for V2X wireless communication at V2X device according to some aspects of the present disclosure.

FIG. 12 is a flow chart of another exemplary method for V2X wireless communication at V2X device according to some aspects of the present disclosure.

FIG. 13 is a flow chart of another exemplary method for V2X wireless communication at V2X device according to some aspects of the present disclosure.

FIG. 14 is a flow chart of another exemplary method for V2X wireless communication at V2X device according to some aspects of the present disclosure.

FIG. 15 is a flow chart of another exemplary method for V2X wireless communication at V2X device according to some aspects of the present disclosure.

FIG. 16 is a flow chart of another exemplary method for V2X wireless communication at V2X device according to some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

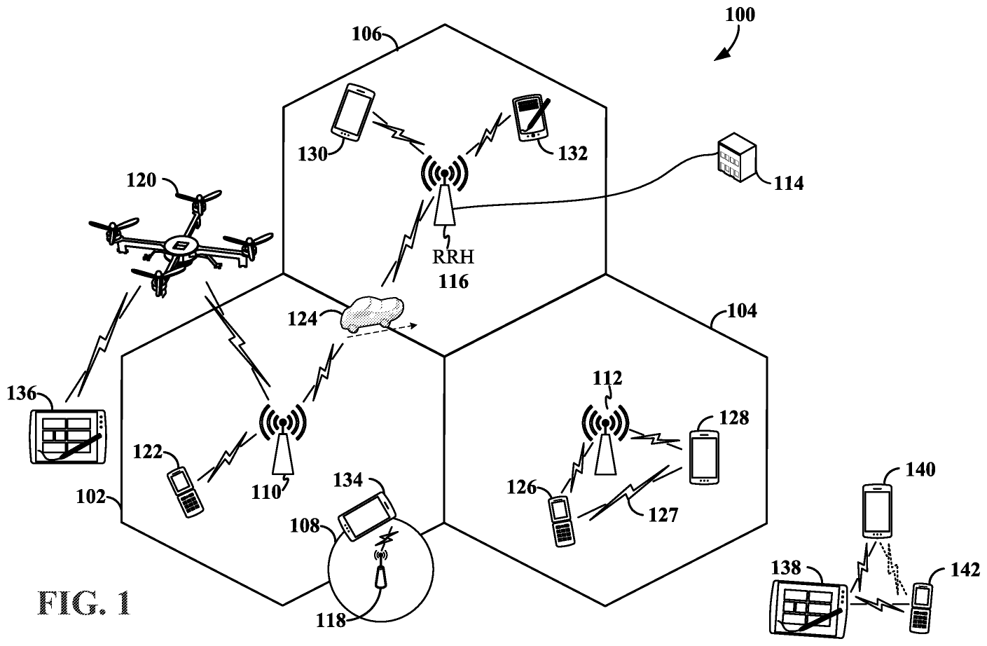

The various concepts presented throughout this disclosure may be implemented across a broad variety of telecommunication systems, network architectures, and communication standards. Referring now to FIG. 1, as an illustrative example without limitation, a schematic illustration of a radio access network 100 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) based on an identification broadcasted over a geographical area from one access point or base station. FIG. 1 illustrates macrocells 102, 104, and 106, and a small cell 108, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective base station (BS) serves each cell. Broadly, a base station is a network element in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB) or some other suitable terminology.

In FIG. 1, two base stations 110 and 112 are shown in cells 102 and 104; and a third base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the base stations 110, 112, and 114 support cells having a large size. Further, a base station 118 is shown in the small cell 108 (e.g., a microcell, picocell, femtocell, home base station, home Node B, home eNode B, etc.) which may overlap with one or more macrocells. In this example, the cell 108 may be referred to as a small cell, as the base station 118 supports a cell having a relatively small size. Cell sizing can be done according to system design as well as component constraints. It is to be understood that the radio access network 100 may include any number of wireless base stations and cells. Further, a relay node may be deployed to extend the size or coverage area of a given cell. The base stations 110, 112, 114, 118 provide wireless access points to a core network for any number of mobile apparatuses.

FIG. 1 further includes a quadcopter or drone 120, which may be configured to function as a base station. That is, in some examples, a cell may not necessarily be stationary, and the geographic area of the cell may move according to the location of a mobile base station such as the quadcopter 120.

In general, base stations may include a backhaul interface for communication with a backhaul portion (not shown) of the network. The backhaul may provide a link between a base station and a core network (not shown), and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; and UE 136 may be in communication with mobile base station 120. Here, each base station 110, 112, 114, 118, and 120 may be configured to provide an access point to a core network (not shown) for all the UEs in the respective cells.

In another example, a mobile network node (e.g., quadcopter 120) may be configured to function as a UE. For example, the quadcopter 120 may operate within cell 102 by communicating with base station 110. In some aspects of the present disclosure, two or more UE (e.g., UEs 126 and 128) may communicate with each other using peer to peer (P2P) or sidelink signals 127 without relaying that communication through a base station (e.g., base station 112).

Unicast or broadcast transmissions of control information and/or traffic information (e.g., user data traffic) from a base station (e.g., base station 110) to one or more UEs (e.g., UEs 122 and 124) may be referred to as downlink (DL) transmission, while transmissions of control information and/or traffic information originating at a UE (e.g., UE 122) may be referred to as uplink (UL) transmissions. In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Of course, these definitions are not required, and any suitable scheme for organizing waveforms may be utilized, and various time divisions of the waveform may have any suitable duration.

The air interface in the RAN 100 may utilize one or more multiplexing and multiple access algorithms to enable simultaneous communication of the various devices. For example, multiple access for uplink (UL) or reverse link transmissions from UEs 122 and 124 to base station 110 may be provided utilizing time division multiple access (TDMA), code division multiple access (CDMA), frequency division multiple access (FDMA), orthogonal frequency division multiple access (OFDMA), sparse code multiple access (SCMA), single-carrier frequency division multiple access (SC-FDMA), resource spread multiple access (RSMA), or other suitable multiple access schemes. Further, multiplexing downlink (DL) or forward link transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), single-carrier frequency division multiplexing (SC-FDM) or other suitable multiplexing schemes.

Further, the air interface in the RAN 100 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per subframe.

In various implementations, the air interface in the radio access network 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

In order for transmissions over the RAN 100 to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

In some examples, access to the air interface may be scheduled, wherein a scheduling entity (e.g., a base station) allocates resources (e.g., time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as a scheduling entity. That is, in some examples, a UE may function as a scheduling entity, scheduling resources for one or more scheduled entities (e.g., one or more other UEs). In other examples, sidelink signals may be used between UEs without necessarily relying on scheduling or control information from a base station. For example, UE 138 is illustrated communicating with UEs 140 and 142. In some examples, the UE 138 is functioning as a scheduling entity or a primary sidelink device, and UEs 140 and 142 may function as a scheduled entity or a non-primary (e.g., secondary) sidelink device. In still another example, a UE, which may be stationary, may function as a scheduling entity in a device-to-device (D2D), peer-to-peer (P2P), or vehicle-to-vehicle (V2V) network, a vehicle-to-everything (V2X), enhanced V2X (eV2X) and/or in a mesh network. In a mesh network example, UEs 140 and 142 may optionally communicate directly with one another in addition to communicating with the scheduling entity 138.

Various aspects of the present disclosure may relate to New Radio (NR) cellular V2X (C-V2X) or other V2X standard, collectively referred to herein as V2X. In some examples, V2X communications may be enabled by sidelink communications scheduled by a roadside unit (RSU), which may be, for example, a stationary UE operating as a scheduling entity for V2X communication. It should be understood that the concepts disclosed herein may not be limited to a particular V2X or C-V2X standard.

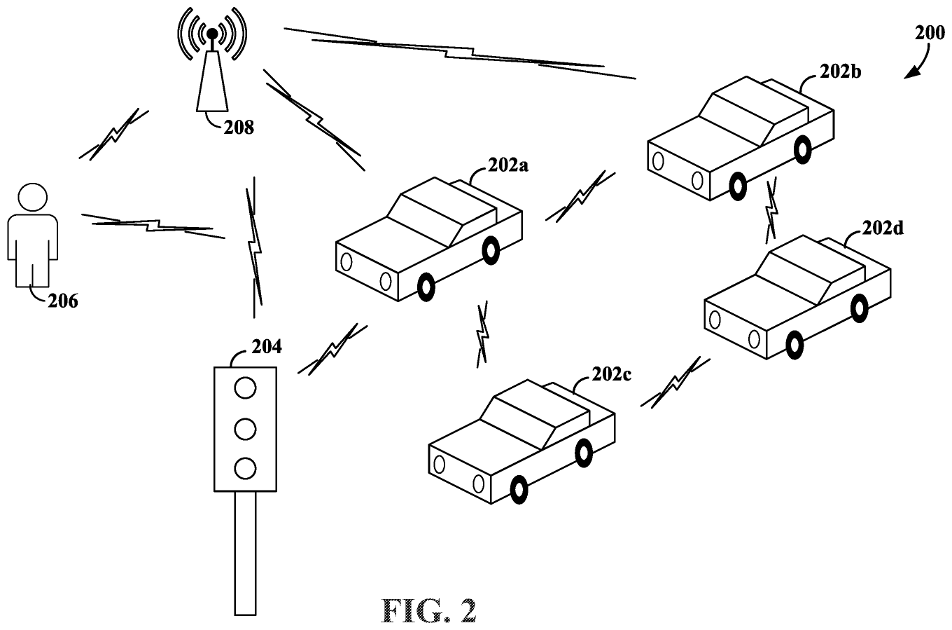

FIG. 2 illustrates an example of a vehicle-to-everything (V2X) wireless communication network 200. A V2X network can connect vehicles 202a-202d to each other (vehicle-to-vehicle (V2V)), to roadway infrastructure 204/205 (vehicle-to-infrastructure (V2I)), to pedestrians/cyclists 206 (vehicle-to-pedestrian (V2P)), and/or to the network 208 (vehicle-to-network (V2N)).

A V2I transmission may be between a vehicle (e.g., vehicle 202a) and a roadside unit (RSU) 204, which may be coupled to various infrastructure 205, such as a traffic light, building, streetlight, traffic camera, tollbooth, or other stationary object. The RSU 204 may act as a base station enabling communication between vehicles 202a-202d, between vehicles 202a-202d and the RSU 204 and between vehicles 202a-202d and mobile devices 206 of pedestrians/cyclists. The RSU 204 may further exchange V2X data gathered from the surrounding environment, such as a connected traffic camera or traffic light controller, V2X connected vehicles 202a-202d, and mobile devices 206 of pedestrians/cyclists, with other RSUs 204 and distribute that V2X data to V2X connected vehicles 202a-202d and pedestrians 206. Examples of V2X data may include status information (e.g., position, speed, acceleration, trajectory, etc.) or event information (e.g., traffic jam, icy road, fog, pedestrian crossing the road, collision, etc.), and may also include video data captured by a camera on a vehicle or coupled to an RSU 204.

Such V2X data may enable autonomous driving and improve road safety and traffic efficiency. For example, the exchanged V2X data may be utilized by a V2X connected vehicle 202a-202d to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device 206 of a pedestrian/cyclist may be utilized to trigger a warning sound, vibration, flashing light, etc., in case of imminent danger.

V2N communication may utilize traditional cellular links to provide cloud services to a V2X device (e.g., within a vehicle 202a-202d or RSU 204, or on a pedestrian 206) for latency-tolerant use cases. For example, V2N may enable a V2X network server to broadcast messages (e.g., weather, traffic, or other information) to V2X devices over a wide area network and may enable V2X devices to send unicast messages to the V2X network server. In addition, V2N communication may provide backhaul services for RSUs 204.

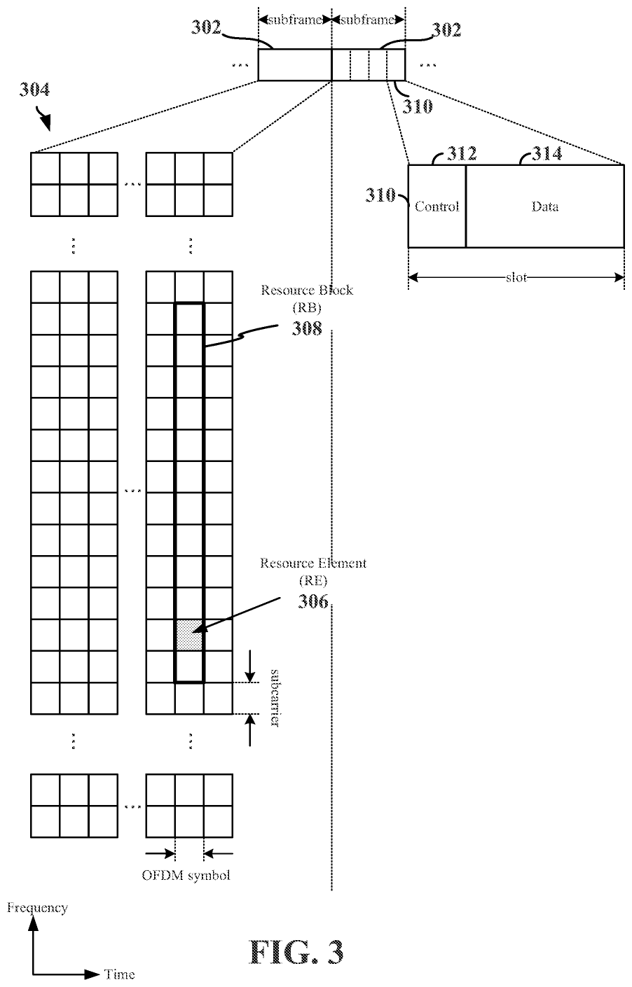

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

Scheduling of UEs or V2X devices for downlink, uplink, or sidelink transmissions typically involves scheduling one or more resource elements 306 within one or more sub-bands. Thus, a UE or V2X device generally utilizes only a subset of the resource grid 304. In some examples, an RB may be the smallest unit of resources that can be allocated to a UE/V2X device. Thus, the more RBs scheduled for a UE/V2X device, and the higher the modulation scheme chosen for the air interface, the higher the data rate for the UE/V2X device.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one to three OFDM symbols). These mini-slots may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals, including but not limited to a demodulation reference signal (DMRS) a control reference signal (CRS), or a sounding reference signal (SRS). These pilots or reference signals may provide for a receiving device to perform channel estimation of the corresponding channel, which may enable coherent demodulation/detection of the control and/or data channels within the RB 308.

In some examples, the slot 310 may be utilized for broadcast or unicast communication. In V2X networks, a broadcast communication may refer to a point-to-multipoint transmission by one V2X device (e.g., a vehicle, roadside unit (RSU), UE of a pedestrian/cyclist, or other V2X device) to other V2X devices. A unicast communication may refer to a point-to-point transmission by one V2X device (e.g., a vehicle, roadside unit (RSU), UE of a pedestrian/cyclist, or other V2X device) to a single other V2X device.

In an example, the control region 312 of the slot 310 may include a physical downlink control channel (PDCCH) including downlink control information (DCI) transmitted by an RSU (base station) towards one or more of a set of V2X devices nearby the RSU. In some examples, the DCI may include synchronization information to synchronize communication by a plurality of V2X devices on the V2X channel. In addition, the DCI may include scheduling information indicating one or more resource blocks within the control region 312 and/or data region 314 allocated to V2X devices for device-to-device (D2D) or sidelink communication. For example, the control region 312 of the slot may further include control information transmitted by V2X devices over the sidelink V2X channel, while the data region 314 of the slot 310 may include V2X data transmitted by V2X devices over the sidelink V2X channel. In some examples, the control information may be transmitted within a physical sidelink control channel (PSCCH), while the data may be transmitted within a physical sidelink shared channel (PSSCH).

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between V2X devices, and those of ordinary skill in the art will recognize that other channels or carriers may be utilized in addition to those illustrated, such as other traffic, control, and feedback channels.

Within a V2X network, such as the V2X network 200 illustrated in FIG. 2, the number of V2X packets that may be received and processed by a V2X device within a subframe 302 or slot 310 is directly related to the number of other nearby V2X devices broadcasting packets in the network. However, the modem system on chip (SoC) within devices that support both V2X and other communication protocols, such as LTE (4G) and NR (5G), may be limited in the amount of traffic (packets) that may be processed within a subframe 302 or slot 310 due to limitations in the performance capability and thermal power envelope. Therefore, as the number of V2X devices, and correspondingly, the number of broadcast V2X packets increases, a receiving V2X device may be unable to properly decode all of the received packets or may shut down, thus resulting in missed V2X data.

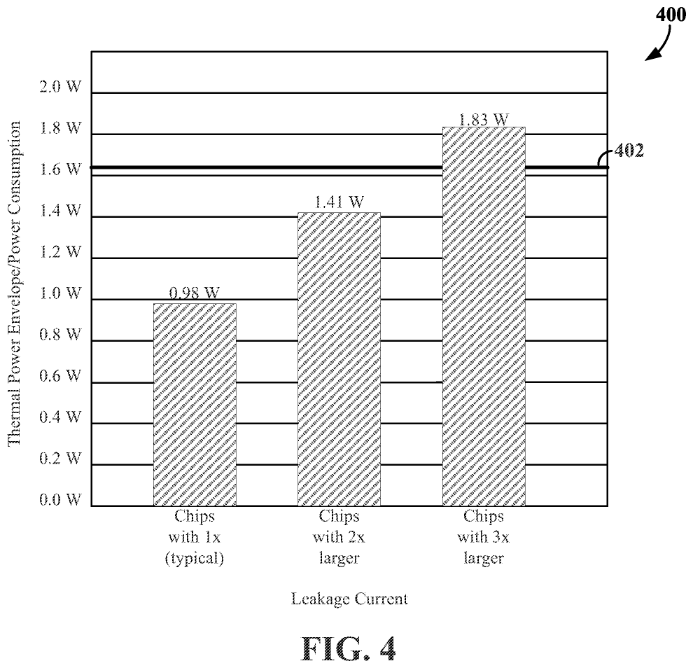

FIG. 4 is a graph 400 illustrating examples of the thermal power envelope and power consumption of modem SoCs with different leakage currents. The leakage current may vary slightly from chip to chip, and this slight variation is reflected in FIG. 4. In the example shown in FIG. 4, modem SoCs with leakage currents of 1× (e.g., chips with a normal or baseline leakage current), 2× (e.g., chips with a 2× larger leaker current than 1× chips), and 3× (e.g., chips with a 3× larger leakage current than 1× chips), respectively, are illustrated. In addition, the thermal power envelope and power consumption was measured for each modem SoC under a high V2X workload of one transmit transport block (TB) every 100 msec and twenty receive TBs every 1 msec. In this example, the thermal power budget 402 to sustain the workload is 1.64 Watts (W). As can be seen in FIG. 4, the modem SoC with the highest leakage current (3×) exceeds the thermal power budget 402 under the high workload, which may result in the modem chip shutting down to protect the modem SoC from silicon damage.

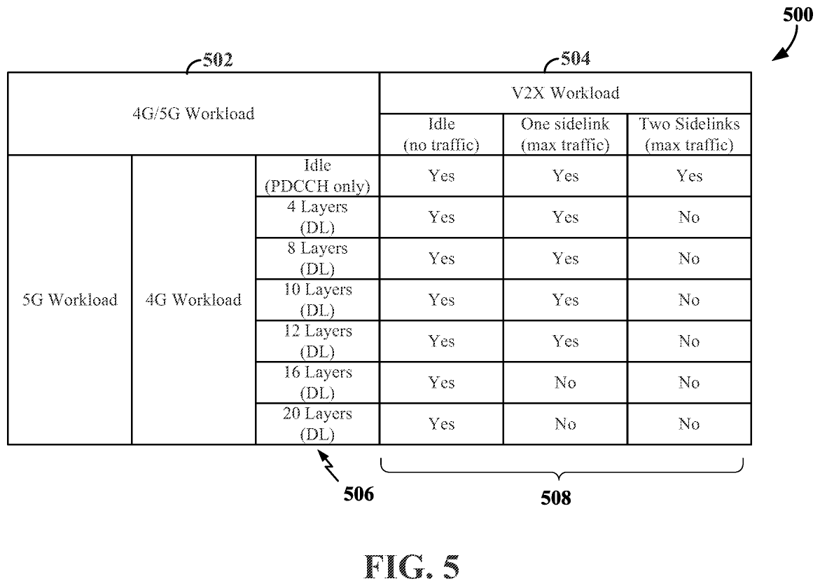

FIG. 5 is a diagram 500 illustrating examples of the performance capability of a modem supporting 4G/5G workloads 502 and a V2X workload 504. The total modem processing capability is limited by the hardware/software/firmware performance of the modem chip. In the example illustrated in FIG. 5, the modem chip supports concurrent processing of 4G (LTE), 5G (NR), and V2X packets. However, as the number of 4G/5G multiple-input-multiple-output (MIMO) layers 506 supported on the downlink increases, the number of V2X sidelinks 508 that may be concurrently supported decreases. For example, only one V2X sidelink 508 may be supported when the number of MIMO layers 506 is equal to or greater than four, and no V2X sidelinks 508 may be supported at or above sixteen MIMO layers 506.

In various aspects of the disclosure, in order to enable a modem chip supporting V2X to operate within the performance and thermal power limits thereof, a V2X device may prioritize communication from other nearby V2X devices and selectively process packets from the other nearby V2X devices based on the assigned priorities. In some aspects of the disclosure, the V2X device may measure one or more performance factors related to the V2X chip/die, and select one or more other nearby V2X devices to receive and process packets therefrom based on the performance factors and the priorities assigned to the other nearby V2X devices.

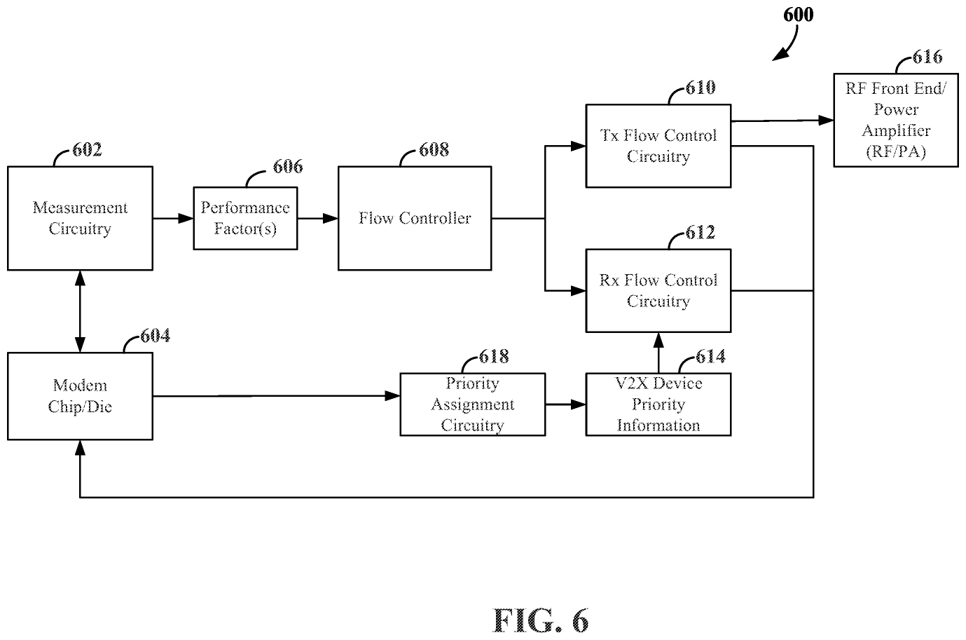

FIG. 6 is a block diagram illustrating an example of a V2X controller 600 according to some aspects of the present disclosure. The V2X controller 600 includes measurement circuitry 602 and a flow controller 608. The measurement circuitry 602 is coupled to a modem chip/die 604 (e.g., a modem SoC) supporting at least V2X communication. In some examples, the modem chip/die 604 may further support 4G (LTE) and/or 5G (NR) cellular communication. The measurement circuitry 602 is configured to measure at least one performance factor 606 related to the modem chip/die 604 and to provide the measured performance factor 606 to the flow controller 608. In some examples, the performance factor 606 may include one or more of a temperature, processor utilization percentage, throughput, or power consumption of the modem chip/die 604.

The flow controller 608 may instruct transmit flow control circuitry 610 and receive flow control circuitry 612 to control at least one characteristic related to the transmission and/or reception of V2X packets based on the at least one measured performance factor 606. For example, the flow controller 608 may instruct the transmit flow control circuitry 610 to control one or more of a transmit power of an RF Front End/Power Amplifier (RF/PA) 616, a transmit packet flow rate of the modem chip/die 604, a type of transmit packets allowed to be transmitted by the modem chip/die 604, or a modulation and coding scheme (MCS) and number of resource blocks (RBs) selected for each of the transmit packets allowed to be transmitted based on the at least one performance factor 606. For example, the transmit flow control circuitry 610 may instruct the modem chip/die 604 to utilize a lower MCS and higher number of RB s to reduce the modem power. However, this may result in a higher transmission power of the RF/PA 616.

In addition, the flow controller 608 may further instruct the receive flow control circuitry 612 to control the rate of packet decoding by the modem chip/die 604. In some examples, the receive flow control circuitry 612 may control the rate of PSSCH (V2X data) decoding and/or the rate of PSCCH (V2X control information) decoding in a subframe or slot. For example, the flow controller 608 may determine a maximum number of packets allowed to be decoded in a subframe or slot and provide the maximum number of packets to the receive flow control circuitry 612. The receive flow control circuitry 612 may then determine a number of packets included in a subframe or slot (e.g., based on received control information from other nearby V2X devices) and select less than all of the received packets for decoding when the number of packets included in the subframe or slot is greater than the maximum number of packets. Thus, the receive flow control circuitry 612 may prevent the modem chip/die 604 from decoding a remaining number of packets above the maximum number of packets.

In various aspects of the disclosure, the receive flow control circuitry 612 may select the packets for decoding (or packets that may be prevented from decoding) based on V2X device priority information 614 indicating a respective priority assigned to each nearby V2X device. The nearby V2X devices may include those V2X devices that transmit packets able to be decoded by the modem chip/die 604. In some examples, the receive flow control circuitry 612 may determine a V2X device identifier of each V2X device that transmitted a packet received in a subframe or slot and utilize the V2X device priority information 614 to select the packets for decoding (or the packets to be prevented from decoding). For example, the receive flow control circuitry 612 may determine the remaining number of packets above the maximum number of packets allowed to be decoded in the subframe or slot, select the packets transmitted from V2X devices with the lowest priority corresponding to the remaining number of packets (or the highest priority corresponding to the number of allowed packets), and instruct the modem chip/die 604 to not decode the selected low priority packets (or to decode the selected high priority packets).

In other examples, the V2X device priority information 614 may include a set of nearby V2X devices from which a subset of V2X devices may be identified, where the subset contains those V2X devices in the set with the highest priority up to the maximum number of V2X devices from which packets may be decoded in a subframe or slot, as indicated by the flow controller 608. For example, the maximum number of packets allowed to be decoded in a subframe or slot may correspond to the maximum number of V2X devices from which packets may be received and decoded in a subframe or slot. In some examples, the set of nearby V2X devices may be represented by a first list of nearby V2X devices and the subset of nearby V2X devices may be represented by a second list of nearby V2X devices, where each nearby V2X device included on the second list is also included on the first list. However, other representations of the set and subset of nearby V2X devices (e.g., a single list where the subset is indicated) may also be utilized and the scope of the present disclosure is not limited to any particular representation. The receive flow control circuitry 612 may then access the subset (or second list, which may also be referred to herein as a whitelist), and instruct the modem chip/die 604 to decode only those packets received from V2X devices on the second list (or in the subset).

In some examples, the subset or second list (whitelist) is updated each subframe or slot to include only those V2X devices that transmitted a packet in that subframe or slot. In this example, the number of packets decoded may be less than the maximum number of packets allowed to be decoded when the second list includes less than the maximum number of V2X devices. Otherwise, the number of packets decoded may be equal to the maximum number of packets allowed to be decoded.

In other examples, the subset or second list (whitelist) is updated only when the flow controller 608 indicates that the maximum number of V2X devices and/or the respective priorities of the nearby V2X devices have changed. For example, the receive flow control circuitry 612 may modify the second list to add or remove V2X devices when the maximum number of V2X devices (maximum number of packets) received from the flow controller 608 changes. The flow controller 608 may periodically receive updated performance factor(s) 606 from the measurement circuitry 602 and modify the maximum number of V2X devices when the updated performance factor(s) 606 indicate that more or fewer V2X packets may be decoded by the modem chip/die 604. In this example, the number of packets decoded may be less than the maximum number of packets allowed to be decoded when packets are not received from all V2X devices in the second list in a subframe or slot or when the second list includes less than the maximum number of V2X devices. However, updating the second list as needed, instead of each subframe or slot, may reduce the processing required to identify V2X devices with the highest priority.

In various aspects of the disclosure, the V2X controller 600 may further include priority assignment circuitry 618 configured to assign a respective priority to each nearby V2X device and generate the V2X device priority information 614. In some examples, the priority assignment circuitry 618 may receive device information from the modem chip/die 604 associated with each of the nearby V2X devices and utilize the device information to assign a respective priority to each of the V2X devices. In some examples, the device information for each V2X device may include one or more of an indication of a priority of the respective V2X device, a periodicity of the packets received from the respective V2X device, a signal strength of the respective V2X device, or V2X data received from the respective V2X device. In some examples, the V2X data may include one or more of vision recognition information indicating a vision condition (e.g., foggy, dark, good vision, etc.) experienced by the respective V2X device, direction of travel of the respective V2X device, a location of the respective V2X device, a speed of the respective V2X device, an automated driving indicator, or a basic safety message (BSM).

The device information may be obtained by the modem chip/die 604 after processing one or more packets received from the V2X devices. Thus, in some examples, the priority assignment circuitry 618 may obtain device information only from those V2X devices on the second list (whitelist). To update the priorities of devices on the first list, but not on the second list, the priority assignment circuitry 618 may occasionally add V2X devices from the first list to the second list in order to update their priority. For example, the V2X device priority information 614 may further indicate the elapsed amount of time that each V2X device has remained outside of the whitelist, and the priority assignment circuitry 618 may add V2X devices from the first list to the second list based on the elapsed amount of time. In some examples, the priority assignment circuitry 618 may compare the elapsed amount of time associated with a V2X device to a threshold, and move the V2X device over to the second list when the elapsed amount of time exceeds the threshold.

In order to add a V2X device to the subset or second list (whitelist), the priority assignment circuitry may either remove a V2X device from the second list or reserve one or more entries in the whitelist for adding V2X devices for the purpose of updating their respective priorities. In addition, as new V2X devices are added to the first list, the priority assignment circuitry 618 may add the new V2X devices to the whitelist to determine their respective priorities.

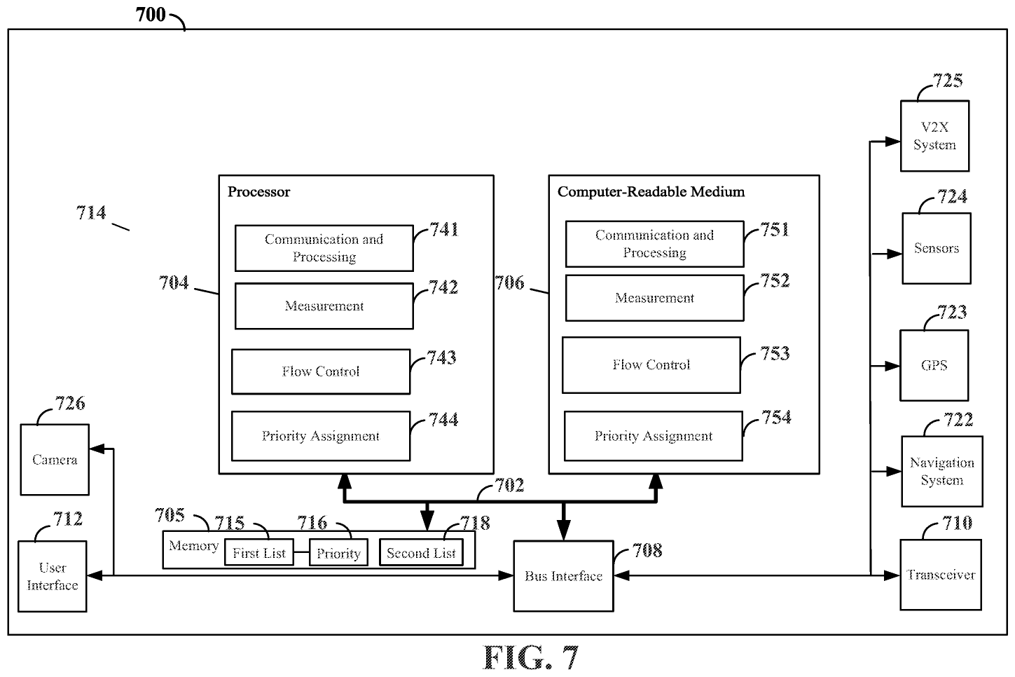

FIG. 7 is a block diagram illustrating an example of a hardware implementation for a V2X device 700 employing a processing system 714. For example, the V2X device 700 may correspond to a vehicle or a mobile or wearable device of a pedestrian/cyclist, as shown and described above in reference to FIG. 2.

The V2X device 700 may be implemented with a processing system 714 that includes one or more processors 704. Examples of processors 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the V2X device 700 may be configured to perform any one or more of the functions described herein. That is, the processor 704, as utilized in the V2X device 700, may be used to implement any one or more of the processes and procedures described below.

In this example, the processing system 714 may be implemented with a bus architecture, represented generally by the bus 702. The bus 702 may include any number of interconnecting buses and bridges depending on the specific application of the processing system 714 and the overall design constraints. The bus 702 links together various circuits including one or more processors (represented generally by the processor 704), a memory 705, and computer-readable media (represented generally by the computer-readable medium 706). The bus 702 may also link various other circuits such as timing sources, peripherals, voltage regulators, and power management circuits, which are well known in the art, and therefore, will not be described any further.

A bus interface 708 provides an interface between the bus 702 and a transceiver 710. The transceiver 710 provides a means for communicating with various other apparatus over a transmission medium (e.g., air interface). The bus interface 708 further provides an interface between the bus 702 and a user interface 712 (e.g., keypad, display, touch screen, speaker, microphone, control knobs, etc.). In addition, the bus interface 708 may provide an interface between the bus 902 and one or more peripherals. For example, peripherals may include a navigation system 722, a global positioning system (GPS) receiver 723, one or more sensors 724, a V2X system 725, and/or a camera 726. In the illustrated example, the V2X system 725 is illustrated external to the processing system 714; however, in another example, the V2X system 725 may be internal to the processing system 714, e.g., operational by the processor 704 utilizing software stored on the computer-readable medium 706.

The V2X system 725 may be configured to obtain V2X data from the navigation system 722, GPS receiver 723, sensors 724, and/or camera 726. In addition, the V2X system 725 may be configured to receive V2X data from one or more nearby V2X devices (e.g., vehicles, mobile devices of pedestrians, RSU's, etc., within a range of the V2X system 725) or from a V2X server via the transceiver 710. In some examples, the V2X data may include one or more of a position (e.g., coordinates) of the vehicle and/or nearby vehicle(s), a speed of the vehicle and/or nearby vehicle(s), a trajectory of the vehicle and/or nearby vehicle(s), a route of the vehicle and/or nearby vehicle(s), traffic information, weather information, road hazard information, the location of one or more pedestrians or cyclists, etc. In addition, the V2X data may include video data captured from the camera 726 attached to the V2X device 700 or received from another V2X device. The V2X data may be maintained, for example, within memory 705 and may further be transmitted to another V2X device via the transceiver 710.

The V2X system 725 may further communicate with the user interface 712 to enable a passenger or user in the vehicle cabin to interact with the V2X system 725. For example, the V2X system 725 may provide alerts or other information obtained from the V2X data to the user via the user interface 712. In some examples, the V2X system 725 may further control one or more components (not shown) of the V2X system to facilitate automated driving and/or assisted driving (e.g., control braking and/or steering for collision-avoidance).

The navigation system 722 provides a means for mapping or planning a route to one or more destinations for the V2X device 700. In the illustrated example, the navigation system 722 is illustrated external to the processing system 714; however, in another example, the navigation system 722 may be internal to the processing system 714, e.g., operational by the processor 704 utilizing software stored on the computer-readable medium 706. The GPS receiver 723 provides a means for communicating with a plurality of GPS satellites and determining position, speed, and trajectory information of the V2X device 700. The one or more sensors 724 may include any suitable set of one or more sensors, including, for example, sensors for determining whether the V2X device 700 is braking or accelerating. The set of sensors 724 may further include other types of gauges, such as a speedometer. The camera 726 may include a back-up camera or other camera attached to the V2X device.

The processor 704 is responsible for managing the bus 702 and general processing, including the execution of software stored on the computer-readable medium 706. The software, when executed by the processor 704, causes the processing system 714 to perform the various functions described below for any particular apparatus. The computer-readable medium 706 and the memory 705 may also be used for storing data that is manipulated by the processor 704 when executing software.

One or more processors 704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The computer-readable medium 706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 706 may reside in the processing system 714, external to the processing system 714, or distributed across multiple entities including the processing system 714. The computer-readable medium 706 may be embodied in a computer program product. By way of example, a computer program product may include a computer-readable medium in packaging materials. In some examples, the computer-readable medium 706 may be part of the memory 705. Those skilled in the art will recognize how best to implement the described functionality presented throughout this disclosure depending on the particular application and the overall design constraints imposed on the overall system.

In some aspects of the disclosure, the processor 704 may include circuitry configured for various functions. For example, the processor 704 may include communication and processing circuitry 741 configured to communicate over a V2X channel to exchange V2X data with other nearby V2X devices. The communication and processing circuitry 741 may further be configured to communicate over a 4G (LTE) and/or 5G (NR) channel with a base station (e.g., eNB or gNB). In some examples, the communication and processing circuitry 741 may correspond to the modem chip/die 604 shown in FIG. 6.

The communication and processing circuitry 741 may further operate in coordination with the V2X system 725 to determine whether the V2X device 700 has generated or obtained V2X data to be transmitted to other V2X devices. In addition, the communication and processing circuitry 741 may further be configured to communicate with a V2X server via a base station (e.g., eNB or gNB) over licensed spectrum allocated to an LTE or NR wireless communication network. For example, the communication and processing circuitry 741 may be configured to receive broadcast V2X data (e.g., weather, traffic, map data, etc.) from the V2X server and/or generate and transmit a unicast message to the V2X server for latency-tolerant use cases via the transceiver 710. The communication and processing circuitry 741 may operate in coordination with communication and processing software 751.

The processor 704 may further include measurement circuitry 742 configured to measure at least one performance factor related to the communication and processing circuitry 741. In some examples, the performance factor may include one or more of a temperature, processor utilization percentage, throughput, or power consumption of the communication and processing circuitry 741. In some examples, the measurement circuitry 742 may correspond to the measurement circuitry 602 shown in FIG. 6. The measurement circuitry 742 may operate in coordination with measurement software 752.

The processor 704 may further include flow control circuitry 743 configured to receive the measured performance factor(s) from the measurement circuitry 742 and control at least one characteristic related to the transmission and/or reception of V2X packets based on the at least one measured performance factor. In some examples, the flow control circuitry 743 may correspond to the flow controller 608, transmit flow control circuitry 610, and receive control circuitry 612 shown in FIG. 6.

Thus, the flow control circuitry 743 may control one or more of a transmit power, a transmit packet flow rate, a type of transmit packets allowed to be transmitted, or a modulation and coding scheme (MCS) and number of resource blocks (RBs) selected for each of the transmit packets allowed to be transmitted based on the at least one performance factor. In addition, the flow control circuitry 743 may further control the rate of packet decoding by the communication and processing circuitry 741. In some examples, the flow control circuitry 743 may control the rate of PSSCH (V2X data) decoding and/or the rate of PSCCH (V2X control information) decoding in a subframe or slot.

The flow control circuitry 743 may further operate together with priority assignment circuitry 744 to maintain a first list 715 (or set) of nearby V2X devices communicating over the V2X channel and a respective priority 716 assigned to each of the nearby V2X devices. The priority assignment circuitry 744 is configured to assign a respective priority 716 to each nearby V2X device based on device information received from the communication and processing circuitry 741 associated with each of the nearby V2X devices. In some examples, the device information for each nearby V2X device may include one or more of an indication of a priority of the respective V2X device, a periodicity of the packets received from the respective V2X device, a signal strength of the respective V2X device, or V2X data received from the respective V2X device. In some examples, the V2X data may include one or more of vision recognition information indicating a vision condition (e.g., foggy, dark, good vision, etc.) experienced by the respective V2X device, direction of travel of the respective V2X device, a location of the respective V2X device, a speed of the respective V2X device, an automated driving indicator, or a basic safety message (BSM). In some examples, the priority assignment circuitry 744 may correspond to the priority assignment circuitry 618 shown in FIG. 6.

The flow control circuitry 743 may further select one of more of the nearby V2X devices in the first list 715 for inclusion in a second list 718 (or subset) based on the at least one measured performance factor and the respective priority 716 assigned to each of the nearby V2X devices. In some examples, the respective priority 716 of each of the nearby V2X devices included in the second list 718 is higher than the respective priority of each of the nearby V2X devices not included in (omitted from) the second list 718. The flow control circuitry 743 may further be configured to access the second list 718 and instruct the communication and processing circuitry 741 to decode only those packets received from nearby V2X devices on the second list 718. The communication and processing circuitry 741 may then ignore packets received from nearby V2X devices omitted from the second list 718.

The flow control circuitry 743 may further modify a number of the nearby V2X devices included in the second list 718 based on the at least one performance factor. For example, the flow control circuitry 743 may increase the number of nearby V2X devices on the second list 718 when the at least one performance factor indicates that the communication and processing circuitry 741 is operating well within the performance capability and thermal power envelope thereof. Similarly, the flow control circuitry 743 may decrease the number of nearby V2X devices on the second list 718 when the at least one performance factor indicates that the performance capability and/or thermal power envelope limits are close to being reached.

The flow control circuitry 743 may further select the nearby V2X devices for inclusion in the second list 718 based on the at least one performance factor and the respective priorities 716 of the nearby V2X devices in the first list 715. In some examples, the flow control circuitry 743 may operate together with the communication and processing circuitry 741 to determine a number of packets received in a subframe. For example, the communication and processing circuitry 741 may receive control information from a plurality of nearby V2X devices in a subframe, where each of the received control information includes an identifier of a nearby V2X device and scheduling information for V2X data (e.g., a packet) transmitted by the nearby V2X device. The flow control circuitry 743 may further determine the number of packets allowed to be decoded in the subframe based on the at least one performance factor. The flow control circuitry 743 may then select less than all of the nearby V2X devices from the first list 715 for inclusion in the second list 718 when the number of packets received in the subframe is greater than the number of packets allowed to be decoded in the subframe. In some examples, each of the nearby V2X devices selected for inclusion in the second list transmitted one of the packets included in the subframe.

In other examples, the flow control circuitry 743 may initially select the nearby V2X devices for inclusion in the second list 718 based upon the performance factor and the respective priorities 716 assigned to the nearby V2X devices. The flow control circuitry 743 may then update the second list 718 when the at least one performance factor indicates the number of nearby V2X devices included in the second list 718 should be modified, when the respective priorities 716 of the nearby V2X devices change, or when new nearby V2X devices are added to the first list 715 that have a higher priority than other nearby V2X devices in the second list 718.

To initially select the nearby V2X devices for inclusion in the second list 718, the flow control circuitry 743 may determine the maximum number of nearby V2X devices that may be included on the second list 718 based on the at least one performance factor. Since the communication and processing circuitry 741 may only process packets received from nearby V2X devices on the second list 718, and therefore, may provide device information to the priority assignment circuitry 744 for only those nearby V2X devices in the second list 718, the flow control circuitry 743 may add and remove nearby V2X devices to and from the second list 718 until all nearby V2X devices have been assigned a respective priority 716. The flow control circuitry 743 may then select up to the maximum number of nearby V2X devices allowed to be on the second list 718 based on the respective assigned priorities of the nearby V2X devices.

To update the second list 718 based on priorities 716, the flow control circuitry 743 may instruct the priority assignment circuitry 744 to update the respective priorities 716 of each of the nearby V2X devices already included on the second list 718. In addition, the flow control circuitry 743 may add one or more of the nearby V2X devices from the first list 715 to the second list 718 that have remained outside the second list 718 for greater than a threshold duration of time to enable the communication and processing circuitry 741 to receive and process packets therefrom. The priority assignment circuitry 744 may then update the respective priorities 716 of each of the added nearby V2X devices on the second list 718 based on device information provided to the priority assignment circuitry 744 from the communication and processing circuitry 741.

In some examples, nearby V2X devices may be added from the first list 715 to the second list 718 for the purpose of updating their respective priorities by removing a corresponding number nearby V2X devices from the second list 718 such that the total number of nearby V2X devices included on the second list 718 does not exceed the maximum number of nearby V2X devices. For example, the flow control circuitry 743 may remove the corresponding number of nearby V2X devices from the second list 718 based on the respective priorities thereof. In other examples, the flow control circuitry 743 may reserve a number of entries in the second list 718 to add one or more nearby V2X devices at a time from the first list 715 to the second list 718 to update their respective priorities 716. A similar procedure may be utilized for new nearby V2X devices that are added to the first list 715 in order to determine their respective priorities 716.

Based on the updated priorities 716 for the nearby V2X devices in the first list 715, the flow control circuitry 743 may update the nearby V2X devices selected from the first list 715 for inclusion in the second list 718. The flow control circuitry 743 may operate in coordination with flow control software 753. In addition, the priority assignment circuitry 744 may operate in coordination with priority assignment software 754.

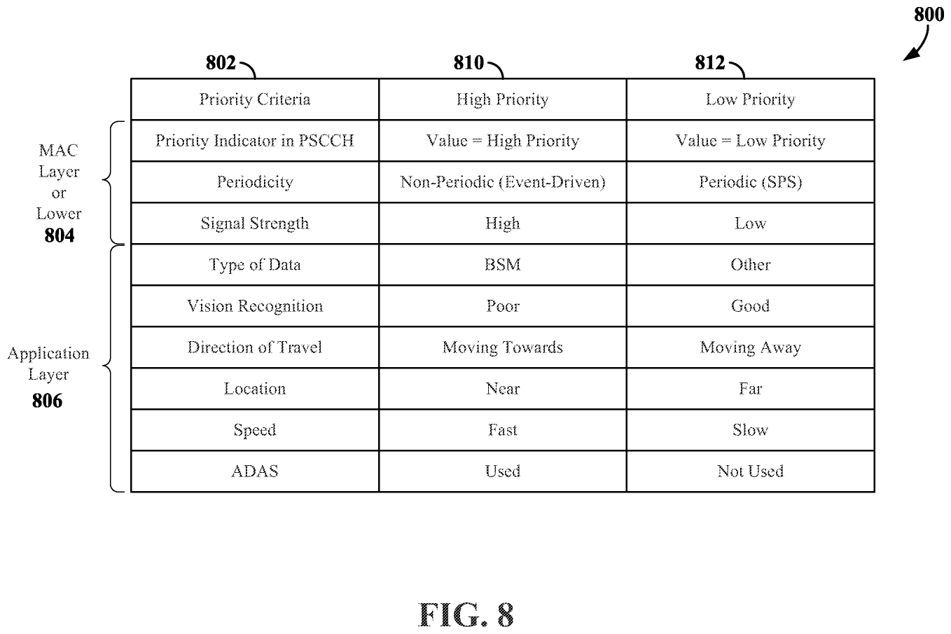

FIG. 8 is a diagram illustrating a table 800 of exemplary priority criteria 802 that may be utilized to assign a priority to a V2X device according to some aspects of the present disclosure. The priority criteria 802 may correspond to device information obtained from packets received and decoded from the V2X device. In some examples, the priority criteria 802 may include device information obtained from the media access control (MAC) layer or lower layers. For example, such MAC layer device information 804 may include a priority indicator indicating a priority value associated with the V2X device. The priority indicator may be included in the PSCCH. In addition, the priority value may be assigned, for example, by the V2X network. If the priority value indicates the V2X has a high priority, a high priority 810 may be assigned to the V2X device. However, if the priority value indicates the V2X has a low priority, a low priority 812 may be assigned to the V2X device.

Other MAC layer device information 804 that may be utilized to assign a priority to the V2X device may include the periodicity of transmissions from the V2X device, and the signal strength of packets received from the V2X device. For example, non-periodic, event-driven transmissions may result in the V2X device being assigned a high priority 810, whereas periodic transmissions (e.g., semi-persistently scheduled packets) may result in the V2X device being assigned a low priority 812. In addition, if the signal strength of the V2X device is high, the V2X device may be assigned a high priority 810, while a lower signal strength may result in the V2X device being assigned a low priority 812.

In some examples, the priority criteria 802 may include device information obtained from the application layer. For example, such application layer device information 806 may include the type of data transmitted by the V2X device, such that if the V2X device transmits a basic safety message (BSM), the V2X device may be assigned a high priority 810. However, if the V2X device is transmitting other type of data, the V2X device may be assigned a low priority 812. Similarly, if the V2X device is transmitting and utilizing advanced driver-assistance system (ADAS) data for automated driving, the V2X device may be assigned a high priority 810, whereas if the V2X is not utilizing ADAS data, the V2X device may be assigned a low priority 812. Other application layer device information 806 may further include vision recognition information (e.g., whether the V2X device is experiences poor vision conditions, and therefore, should have a higher priority 810), direction of travel of the V2X devices (e.g., moving towards or moving away), location of the V2X device (e.g., close or far), and/or speed of the V2X device (e.g., moving fast or slow).

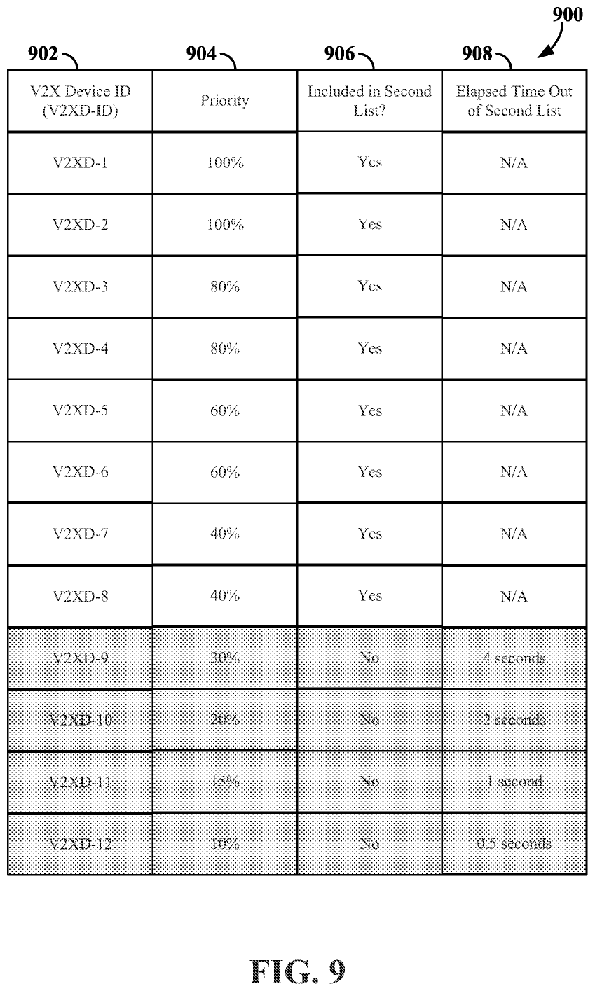

FIG. 9 is a diagram illustrating an exemplary list 900 of nearby V2X devices according to some aspects of the present disclosure. The list 900 may correspond to, for example, the first list 715 (or set), shown in FIG. 7. The list 900 includes a respective identifier of each V2X device (e.g., V2XD-ID 902). The list 900 may further include a respective priority 904 assigned to each V2X device. The priority 904 may correspond to, for example, the priority 716 shown in FIG. 7. In addition, the list 900 may include a second list indicator 906 of whether the V2X device is included in the second list (e.g., second list 718 (or subset), shown in FIG. 7). The list 900 may further include an elapsed time 908 indicating the elapsed time that each V2X device has remained outside of the second list.

In the example shown in FIG. 9, V2XD-1 through V2XD-8 have the highest priorities 904, and therefore, are included in the second list (e.g., the second list indicator 906 reflects “Yes”). Since V2XD-1 through V2XD-8 are included in the second list, the elapsed time is zero (shown as N/A). For the remaining V2X devices in the list (e.g., V2XD-9 through V2XD-12), these V2X devices have the lowest priority 904, and therefore, are omitted from the second list (e.g., the second list indicator reflects “No”). In addition, V2XD-9 through V2XD-12 further include an elapsed time 908 that each have remained off the second list that may be used to determine when to update the priority 904 of each of the V2X devices not on the second list. The priority 904 of each V2X device is represented as a criticality percentage (e.g., 0%-100%). However, it should be understood that other measures of the priority 904 may also be utilized.

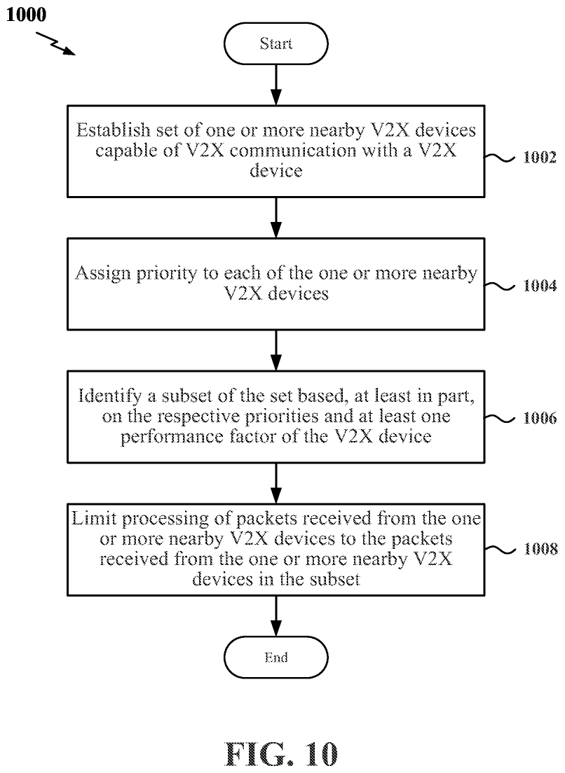

FIG. 10 is a flow chart 1000 of an exemplary method for V2X wireless communication at V2X device according to some aspects of the present disclosure. As described below, some or all illustrated features may be omitted in a particular implementation within the scope of the present disclosure, and some illustrated features may not be required for implementation of all embodiments. In some examples, the method may be performed by the V2X device 700, as described above and illustrated in FIG. 7, by a processor or processing system, or by any suitable means for carrying out the described functions.

At block 1002, the V2X device may establish a set of one or more nearby V2X devices capable of communication with the V2X device. In some examples, the V2X device may maintain a first list of nearby V2X devices. In some examples, the first list may correspond to the list 900 shown in FIG. 9 and/or the list 715 shown in FIG. 7. For example, the flow control circuitry 743 shown and described above in connection with FIG. 7 may establish the set of one or more nearby V2X devices.

At block 1004, the V2X device may assign a respective priority to each of the one or more nearby V2X devices in the set. In some examples, the priority may be assigned using the priority criteria 802 (e.g., device information obtained from packets transmitted by the nearby V2X devices) shown in the table 800 of FIG. 8. For example, the priority assignment circuitry 744 shown and described above in connection with FIG. 7 may assign the respective priority to each of the one or more nearby V2X devices.

At block 1006, the V2X device may identify a subset of the set based, at least in part, on the assigned respective priorities and at least one performance factor of the V2X device. In some examples, the performance factor may include one or more of a die temperature, a processor utilization percentage, a throughput, or a power consumption of the V2X device. In some examples, the subset may include a second list of one or more nearby V2X devices selected for inclusion in both the first list and a second list. Each of the nearby V2X devices included in the second list may have a higher priority than the nearby V2X devices omitted from the second list (e.g., nearby V2X devices included in only the first list). The number of V2X devices included in the second list may be determined, for example, based on the performance factor. For example, the flow control circuitry 743 shown and described above in connection with FIG. 7 may identify the subset of the set.

At block 1008, the V2X device may limit processing of packets received from the one or more nearby V2X devices to the packets received from the one or more nearby V2X devices in the subset (e.g., the second list). In some examples, the V2X device may be prevented from decoding packets received from nearby V2X devices not in the second list. For example, the flow control circuitry 743 together with the communication and processing circuitry 741 and the transceiver 710 shown and described above in connection with FIG. 7 may receive and process packets from the nearby V2X devices included in the second list and may ignore packets received from the nearby V2X devices included in the second list.

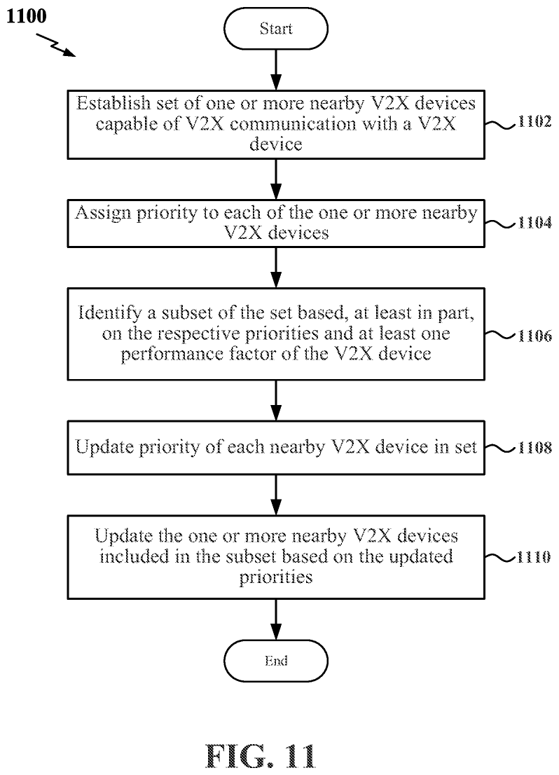

FIG. 11 is a flow chart 1100 of an exemplary method for V2X wireless communication at V2X device according to some aspects of the present disclosure. As described below, some or all illustrated features may be omitted in a particular implementation within the scope of the present disclosure, and some illustrated features may not be required for implementation of all embodiments. In some examples, the method may be performed by the V2X device 700, as described above and illustrated in FIG. 7, by a processor or processing system, or by any suitable means for carrying out the described functions.

At block 1102, the V2X device may establish a set of one or more nearby V2X devices capable of communication with the V2X device. In some examples, the V2X device may maintain a first list of nearby V2X devices. In some examples, the first list may correspond to the list 900 shown in FIG. 9 and/or the list 715 shown in FIG. 7. For example, the flow control circuitry 743 shown and described above in connection with FIG. 7 may establish the set of one or more nearby V2X devices.

At block 1104, the V2X device may assign a respective priority to each of the one or more nearby V2X devices in the set. In some examples, the priority may be assigned using the priority criteria 802 (e.g., device information obtained from packets transmitted by the nearby V2X devices) shown in the table 800 of FIG. 8. For example, the priority assignment circuitry 744 shown and described above in connection with FIG. 7 may assign the respective priority to each of the one or more nearby V2X devices.

At block 1106, the V2X device may identify a subset of the set based, at least in part, on the assigned respective priorities and at least one performance factor of the V2X device. In some examples, the performance factor may include one or more of a die temperature, a processor utilization percentage, a throughput, or a power consumption of the V2X device. In some examples, the subset may include a second list of one or more nearby V2X devices selected for inclusion in both the first list and a second list. Each of the nearby V2X devices included in the second list may have a higher priority than the nearby V2X devices omitted from the second list (e.g., nearby V2X devices included in only the first list). The number of V2X devices included in the second list may be determined, for example, based on the performance factor. For example, the flow control circuitry 743 shown and described above in connection with FIG. 7 may identify the subset of the set.

At block 1108, the V2X device may update the priority of each of the nearby V2X devices in the set. In some examples, the V2X device may update the priority of each of the nearby V2X devices included in the second list by processing packets received from the nearby V2X devices in the second list and updating the priority of those nearby V2X devices within the first list. The V2X device may then update the priority of other nearby V2X devices not included in the second list by occasionally adding nearby V2X devices from the first list to the second list in order to update their priority. For example, the V2X device may add nearby V2X devices from the first list to the second list based on the elapsed amount of time that the nearby V2X devices have remained outside the second list. In addition, the V2X device may either remove a nearby V2X device from the second list or reserve one or more entries in the second list for adding nearby V2X devices for the purpose of updating their respective priorities. For example, the priority assignment circuitry 744 shown and described above in connection with FIG. 7 may update the respective priorities of the V2X devices in the first list.

At block 1110, the V2X device may update the one or more nearby V2X devices included in the subset (e.g., the second list) based on the updated priorities of the nearby V2X devices in the first list. For example, the flow control circuitry 743 shown and described above in connection with FIG. 7 may update the one or more V2X devices selected for inclusion in the second list.

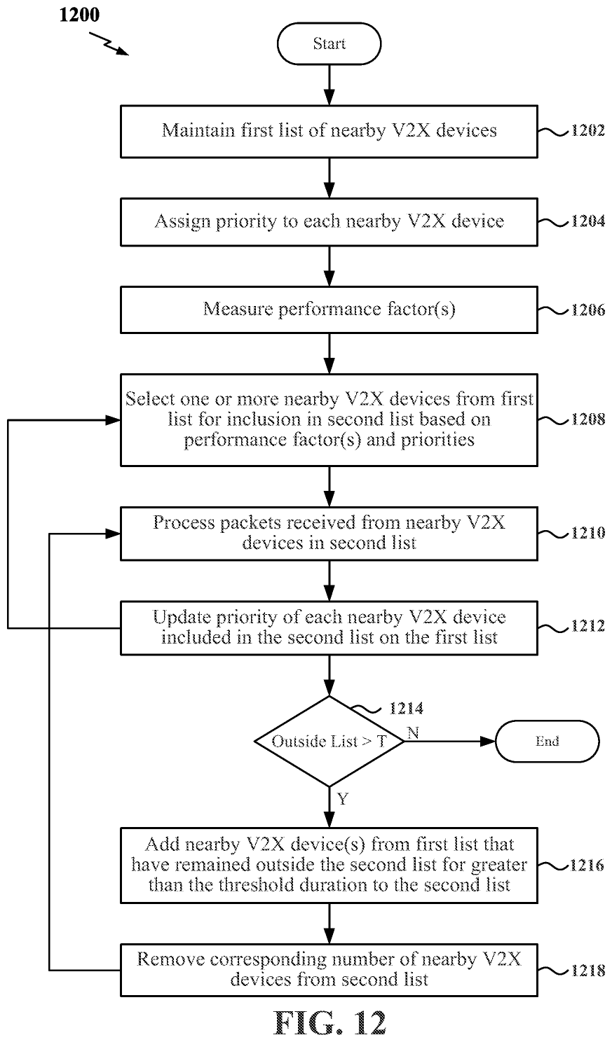

FIG. 12 is a flow chart 1200 of an exemplary method for V2X wireless communication at V2X device according to some aspects of the present disclosure. As described below, some or all illustrated features may be omitted in a particular implementation within the scope of the present disclosure, and some illustrated features may not be required for implementation of all embodiments. In some examples, the method may be performed by the V2X device 700, as described above and illustrated in FIG. 7, by a processor or processing system, or by any suitable means for carrying out the described functions.

At block 1202, the V2X device may maintain a first list (or set) of nearby V2X devices. In some examples, the first list may correspond to the list 900 shown in FIG. 9 and/or the list 715 shown in FIG. 7. For example, the flow control circuitry 743 shown and described above in connection with FIG. 7 may maintain the first list.

At block 1204, the V2X device may assign a respective priority to each of the nearby V2X devices in the first list. In some examples, the priority may be assigned using the priority criteria 802 (e.g., device information obtained from packets transmitted by the nearby V2X devices) shown in the table 800 of FIG. 8. For example, the priority assignment circuitry 744 shown and described above in connection with FIG. 7 may assign the respective priority to each of the V2X devices in the first list.

At block 1206, the V2X device may measure at least one performance factor of the V2X device. In some examples, the performance factor may include one or more of a die temperature, a processor utilization percentage, a throughput, or a power consumption of the V2X device. For example, the measurement circuitry 742 shown and described above in connection with FIG. 7 may measure the performance factor(s).

At block 1208, the V2X device may select one or more the nearby V2X devices in the first list for inclusion in both the first list and a second list (or subset) based on the at least one performance factor and the respective priority of each of the nearby V2X devices. Each of the nearby V2X devices included in the second list may have a higher priority than the nearby V2X devices not selected for inclusion in the second list. The number of V2X devices included in the second list may be determined, for example, based on the performance factor. For example, the flow control circuitry 743 shown and described above in connection with FIG. 7 may select the nearby V2X devices for inclusion in the second list.

At block 1210, the V2X device may process packets received from nearby V2X devices in the second list. For example, the flow control circuitry 743 together with the communication and processing circuitry 741 and the transceiver 710 shown and described above in connection with FIG. 7 may receive and process packets from the nearby V2X devices included in the second list.

At block 1212, the V2X device may update the priority of each of the nearby V2X devices included in the second list on the first list based on the packets received from the nearby V2X devices in the second list in block 1210. For example, the priority assignment circuitry 744 shown and described above in connection with FIG. 7 may update the respective priority of each of the nearby V2X devices in the second list.

At block 1214, the V2X device may determine whether one or more additional nearby V2X devices included in only the first list have remained outside the second list for greater than a threshold duration of time. If one or more additional nearby V2X devices have remained outside the second list for greater than the threshold duration (Y branch of block 1214), at blocks 1216 and 1218, the V2X device may add the one or more additional nearby V2X devices from the first list to the second list and remove a corresponding number of V2X devices from the second list. For example, the flow control circuitry 743 shown and described above in connection with FIG. 7 may add and remove nearby V2X devices from the second list.

The method then proceeds to blocks 1210 and 1212, where the V2X device may process packets received from the nearby V2X devices included in the second list and update the respective priorities of each of the nearby V2X devices now included in the second list on the first list. The method then proceeds to block 1208, where the V2X device may update the selection of one or more nearby V2X devices in the second list based on the updated priorities of the nearby V2X devices in the first list. In addition, the method further proceeds to block 1214, where the V2X device determines whether one or more other nearby V2X devices have remained outside the second list for the threshold duration of time. If one or more other nearby V2X devices have remained outside the second list for the threshold duration of time (Y branch of block 1214), the V2X device repeats the addition of nearby V2X devices into the second list at block 1216 in order to update the respective priorities of the other nearby V2X devices and the selection of nearby V2X devices included in the second list.

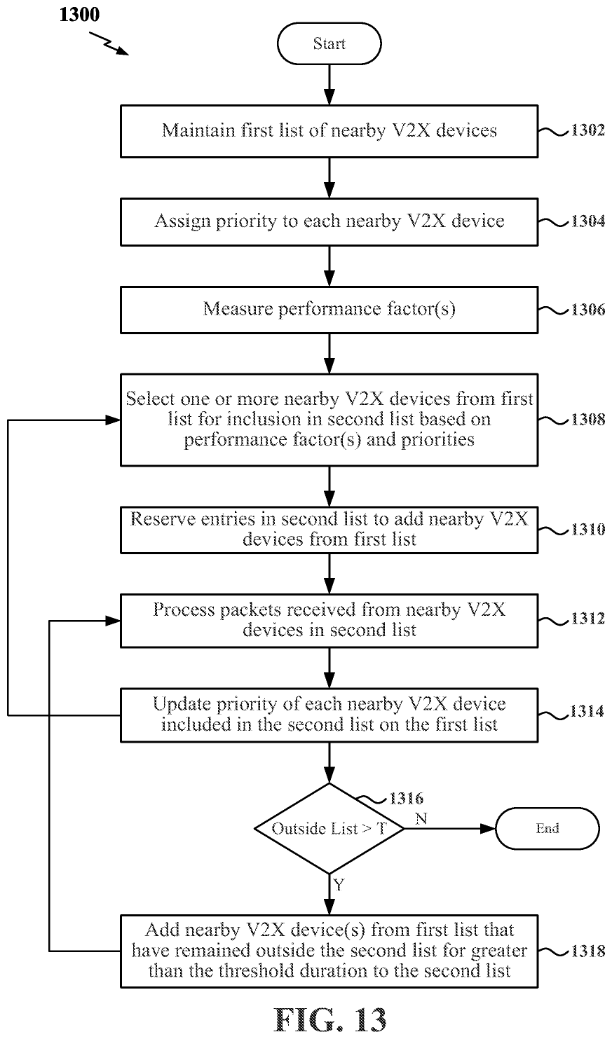

FIG. 13 is a flow chart 1300 of an exemplary method for V2X wireless communication at V2X device according to some aspects of the present disclosure. As described below, some or all illustrated features may be omitted in a particular implementation within the scope of the present disclosure, and some illustrated features may not be required for implementation of all embodiments. In some examples, the method may be performed by the V2X device 700, as described above and illustrated in FIG. 7, by a processor or processing system, or by any suitable means for carrying out the described functions.

At block 1302, the V2X device may maintain a first list (or set) of nearby V2X devices. In some examples, the first list may correspond to the list 900 shown in FIG. 9 and/or the list 715 shown in FIG. 7. For example, the flow control circuitry 743 shown and described above in connection with FIG. 7 may maintain the first list.

At block 1304, the V2X device may assign a respective priority to each of the nearby V2X devices in the first list. In some examples, the priority may be assigned using the priority criteria 802 (e.g., device information obtained from packets transmitted by the nearby V2X devices) shown in the table 800 of FIG. 8. For example, the priority assignment circuitry 744 shown and described above in connection with FIG. 7 may assign the respective priority to each of the V2X devices in the first list.

At block 1306, the V2X device may measure at least one performance factor of the V2X device. In some examples, the performance factor may include one or more of a die temperature, a processor utilization percentage, a throughput, or a power consumption of the V2X device. For example, the measurement circuitry 742 shown and described above in connection with FIG. 7 may measure the performance factor(s).

At block 1308, the V2X device may select one or more the nearby V2X devices in the first list for inclusion in both the first list and a second list (or subset) based on the at least one performance factor and the respective priority of each of the nearby V2X devices. Each of the nearby V2X devices included in the second list may have a higher priority than the nearby V2X devices not selected for inclusion in the second list. The number of V2X devices included in the second list may be determined, for example, based on the performance factor. For example, the flow control circuitry 743 shown and described above in connection with FIG. 7 may select the nearby V2X devices for inclusion in the second list.

At block 1310, the V2X device may reserve one or more entries in the second list to add one or more additional V2X devices from the first list to the second list in order to update the respective priorities thereof. For example, the flow control circuitry 743 shown and described above in connection with FIG. 10 may reserve one or more entries in the second list.

At block 1312, the V2X device may process packets received from nearby V2X devices in the second list. For example, the flow control circuitry 743 together with the communication and processing circuitry 741 and the transceiver 710 shown and described above in connection with FIG. 7 may receive and process packets from the nearby V2X devices included in the second list.

At block 1314, the V2X device may update the priority of each of the nearby V2X devices included in the second list on the first list based on the packets received from the nearby V2X devices in the second list in block 1311. For example, the priority assignment circuitry 744 shown and described above in connection with FIG. 7 may update the respective priority of each of the nearby V2X devices in the second list.

At block 1316, the V2X device may determine whether one or more additional nearby V2X devices included in only the first list have remained outside the second list for greater than a threshold duration of time. If one or more additional nearby V2X devices have remained outside the second list for greater than the threshold duration (Y branch of block 1316), at block 1318, the V2X device may add the one or more additional nearby V2X devices from the first list into the one or more reserved entries in the second list. For example, the flow control circuitry 743 shown and described above in connection with FIG. 7 may add and remove nearby V2X devices from the second list.

The method then proceeds to blocks 1312 and 1314, where the V2X device may process packets received from the nearby V2X devices included in the second list and update the respective priorities of each of the nearby V2X devices now included in the second list on the first list. The method then proceeds to block 1308 and 1310, where the V2X device may update the selection of one or more nearby V2X devices in the second list based on the updated priorities of the nearby V2X devices in the first list and reserve one or more entries in the second list to add other V2X devices from the first list to the second list. In addition, the method further proceeds to block 1316, where the V2X device determines whether one or more other nearby V2X devices have remained outside the second list for the threshold duration of time. If one or more other nearby V2X devices have remained outside the second list for the threshold duration of time (Y branch of block 1316), the V2X device repeats the addition of the other nearby V2X devices into the one or more reserved entries in the second list at block 1318 in order to update the respective priorities of the other nearby V2X devices and the selection of nearby V2X devices included in the second list.

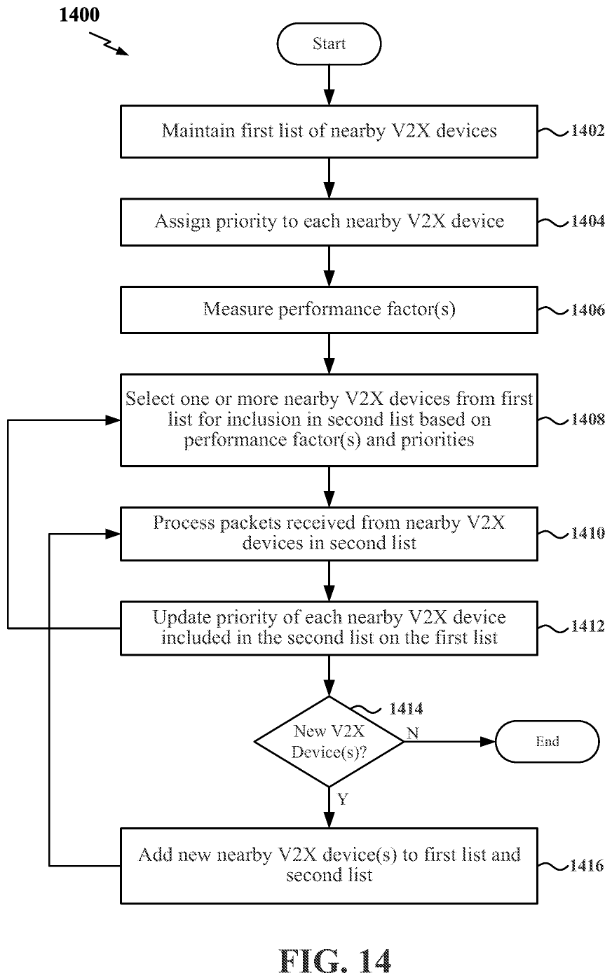

FIG. 14 is a flow chart 1400 of an exemplary method for V2X wireless communication at V2X device according to some aspects of the present disclosure. As described below, some or all illustrated features may be omitted in a particular implementation within the scope of the present disclosure, and some illustrated features may not be required for implementation of all embodiments. In some examples, the method may be performed by the V2X device 700, as described above and illustrated in FIG. 7, by a processor or processing system, or by any suitable means for carrying out the described functions.

At block 1402, the V2X device may maintain a first list (or set) of nearby V2X devices. In some examples, the first list may correspond to the list 900 shown in FIG. 9 and/or the list 715 shown in FIG. 7. For example, the flow control circuitry 743 shown and described above in connection with FIG. 7 may maintain the first list.

At block 1404, the V2X device may assign a respective priority to each of the nearby V2X devices in the first list. In some examples, the priority may be assigned using the priority criteria 802 (e.g., device information obtained from packets transmitted by the nearby V2X devices) shown in the table 800 of FIG. 8. For example, the priority assignment circuitry 744 shown and described above in connection with FIG. 7 may assign the respective priority to each of the V2X devices in the first list.

At block 1406, the V2X device may measure at least one performance factor of the V2X device. In some examples, the performance factor may include one or more of a die temperature, a processor utilization percentage, a throughput, or a power consumption of the V2X device. For example, the measurement circuitry 742 shown and described above in connection with FIG. 7 may measure the performance factor(s).

At block 1408, the V2X device may select one or more the nearby V2X devices in the first list for inclusion in both the first list and a second list (or subset) based on the at least one performance factor and the respective priority of each of the nearby V2X devices. Each of the nearby V2X devices included in the second list may have a higher priority than the nearby V2X devices not selected for inclusion in the second list. The number of V2X devices included in the second list may be determined, for example, based on the performance factor. For example, the flow control circuitry 743 shown and described above in connection with FIG. 7 may select the nearby V2X devices for inclusion in the second list.

At block 1410, the V2X device may process packets received from nearby V2X devices in the second list. For example, the flow control circuitry 743 together with the communication and processing circuitry 741 and the transceiver 710 shown and described above in connection with FIG. 7 may receive and process packets from the nearby V2X devices included in the second list.

At block 1412, the V2X device may update the priority of each of the nearby V2X devices included in the second list on the first list based on the packets received from the nearby V2X devices in the second list in block 1210. For example, the priority assignment circuitry 744 shown and described above in connection with FIG. 7 may update the respective priority of each of the nearby V2X devices in the second list.

At block 1414, the V2X device may determine whether there are one or more new nearby V2X devices. If there are new V2X device(s) (Y branch of block 1412), at block 1416, the new V2X device(s) are added to the first list and the second list. In some examples, a corresponding number of nearby V2X devices may be removed from the second list to add the new nearby V2X device(s) to the second list. In other examples, the new V2X device(s) may be added into reserved entries in the second list. For example, the flow control circuitry 743 shown and described above in connection with FIG. 7 may add the new nearby V2X device(s) to the first and second lists.

The method then proceeds to blocks 1410 and 1412, where the V2X device may process packets received from the nearby V2X devices (including the new V2X devices) included in the second list and update the respective priorities of each of the nearby V2X devices now included in the second list on the first list. The method then proceeds to block 1408, where the V2X device may update the selection of one or more nearby V2X devices in the second list based on the updated priorities of the nearby V2X devices in the first list. In addition, the method further proceeds to block 1414, where the V2X device determines whether there are one or more additional new nearby V2X devices. If there are one or more additional new nearby V2X devices (Y branch of block 1414), the V2X device repeats the addition of the new nearby V2X devices into the first list and the second list at block 1416.

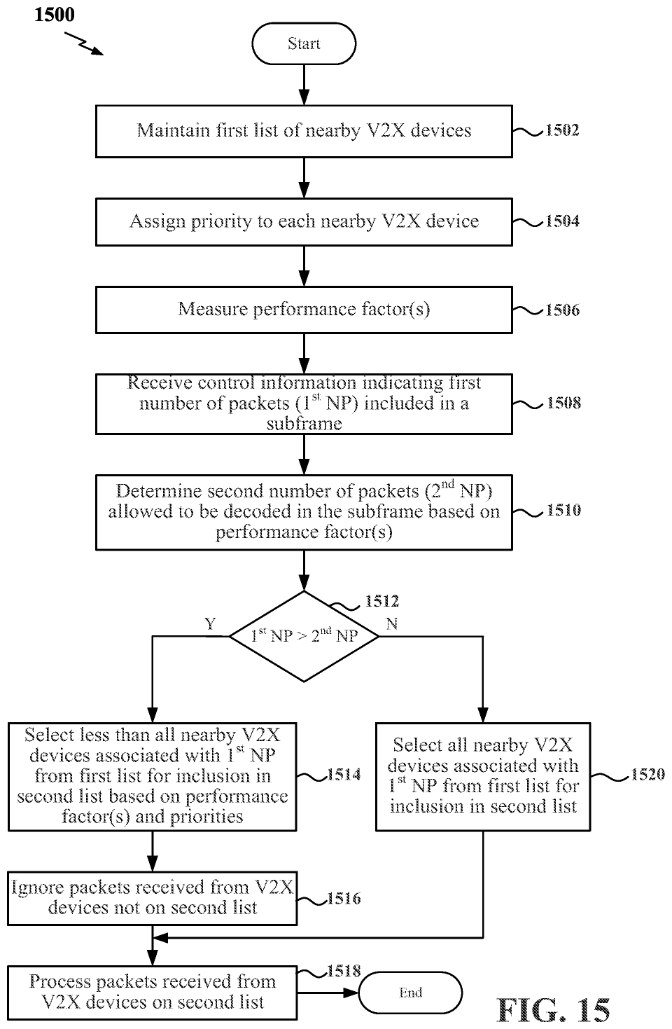

FIG. 15 is a flow chart 1500 of an exemplary method for V2X wireless communication at V2X device according to some aspects of the present disclosure. As described below, some or all illustrated features may be omitted in a particular implementation within the scope of the present disclosure, and some illustrated features may not be required for implementation of all embodiments. In some examples, the method may be performed by the V2X device 700, as described above and illustrated in FIG. 7, by a processor or processing system, or by any suitable means for carrying out the described functions.

At block 1502, the V2X device may maintain a first list (or set) of nearby V2X devices. In some examples, the first list may correspond to the list 900 shown in FIG. 9 and/or the list 715 shown in FIG. 7. For example, the flow control circuitry 743 shown and described above in connection with FIG. 7 may maintain the first list.

At block 1504, the V2X device may assign a respective priority to each of the nearby V2X devices in the first list. In some examples, the priority may be assigned using the priority criteria 802 (e.g., device information obtained from packets transmitted by the nearby V2X devices) shown in the table 800 of FIG. 8. For example, the priority assignment circuitry 744 shown and described above in connection with FIG. 7 may assign the respective priority to each of the V2X devices in the first list.

At block 1506, the V2X device may measure at least one performance factor of the V2X device. In some examples, the performance factor may include one or more of a die temperature, a processor utilization percentage, a throughput, or a power consumption of the V2X device. For example, the measurement circuitry 742 shown and described above in connection with FIG. 7 may measure the performance factor(s).

At block 1508, the V2X device may receive control information indicating a first number of packets (1^{st} NP) included in a subframe. For example, the V2X device may receive control information from a plurality of nearby V2X devices in a subframe, where each of the received control information includes an identifier of a nearby V2X device and scheduling information for V2X data (e.g., a packet) transmitted by the nearby V2X device. For example, the flow control circuitry 743 together with the communication and processing circuitry 741 shown and described above in connection with FIG. 7 may receive the control information indicating the 1^{st} NP.

At block 1510, the V2X device may determine a second number of packets (2^{nd} NP) allowed to be decoded in the subframe based on the at least one performance factor. For example, the flow control circuitry 743 shown and described above in connection with FIG. 7 may determine the 2^{nd} NP.

At block 1512, the V2X device may determine whether the 1^{st} NP is greater than the 2^{nd} NP. If the 1^{st} NP is greater than the 2^{nd} NP (Y branch of block 1512), at block 1514, the V2X device may select less than all of the nearby V2X devices from the first list for inclusion in both the first list and a second list (or subset) based on the at least one measured performance factor and the respective priority of each of the nearby V2X devices. In some examples, each of the nearby V2X devices selected for inclusion in the second list transmitted one of the packets included in the subframe. In addition, each of the nearby V2X devices included in the second list may have a higher priority than the nearby V2X devices omitted from the second list. For example, the flow control circuitry 743 shown and described above in connection with FIG. 7 may select the nearby V2X devices for inclusion in the second list.

At block 1516, the V2X device may then ignore packets received from V2X devices omitted from the second list (e.g., V2X devices included in only the first list and not the second list). In some examples, the V2X device may be prevented from decoding packets received from nearby V2X devices not in the second list. For example, the flow control circuitry 743 together with the communication and processing circuitry 741 and the transceiver 710 shown and described above in connection with FIG. 7 may ignore packets received from the nearby V2X devices included in the second list.

At block 1518, the V2X device may process packets received from nearby V2X devices in the second list. For example, the flow control circuitry 743 together with the communication and processing circuitry 741 and the transceiver 710 shown and described above in connection with FIG. 7 may receive and process only those 1^{st} NP received from the nearby V2X devices included in the second list.

If the 1^{st} NP is not greater than the 2^{nd} NP (N branch of block 1512), at block 1520, the V2X device may select all nearby V2X devices associated with the 1^{st} NP from the first list for inclusion in the second list. The V2X device may then process all of the packets received from the nearby V2X devices in the subframe (e.g., packets received from the nearby V2X devices included in the second list) at block 1518. For example, the flow control circuitry 743 together with the communication and processing circuitry 741 and the transceiver 710 shown and described above in connection with FIG. 7 may receive and process all of the 1^{st} NP received from the nearby V2X devices included in the second list.

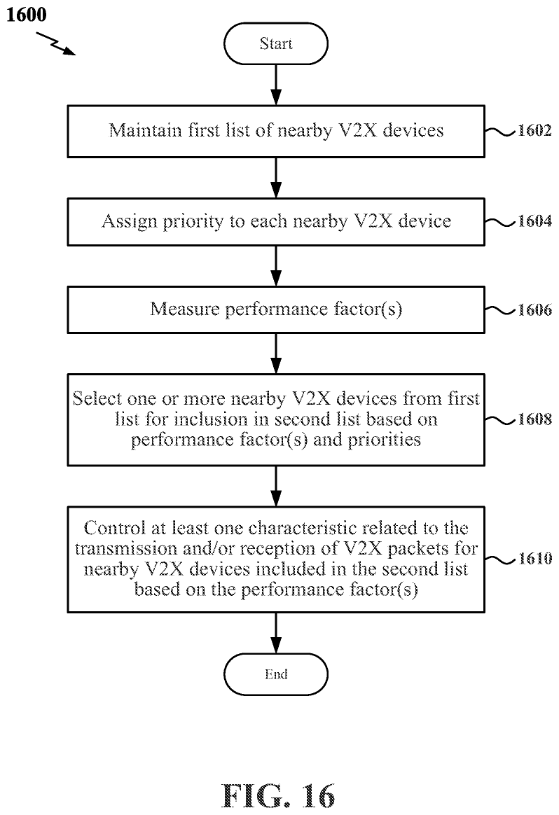

FIG. 16 is a flow chart 1600 of an exemplary method for V2X wireless communication at V2X device according to some aspects of the present disclosure. As described below, some or all illustrated features may be omitted in a particular implementation within the scope of the present disclosure, and some illustrated features may not be required for implementation of all embodiments. In some examples, the method may be performed by the V2X device 700, as described above and illustrated in FIG. 7, by a processor or processing system, or by any suitable means for carrying out the described functions.

At block 1602, the V2X device may maintain a first list (or set) of nearby V2X devices. In some examples, the first list may correspond to the list 900 shown in FIG. 9 and/or the list 715 shown in FIG. 7. For example, the flow control circuitry 743 shown and described above in connection with FIG. 7 may maintain the first list.

At block 1604, the V2X device may assign a respective priority to each of the nearby V2X devices in the first list. In some examples, the priority may be assigned using the priority criteria 802 (e.g., device information obtained from packets transmitted by the nearby V2X devices) shown in the table 800 of FIG. 8. For example, the priority assignment circuitry 744 shown and described above in connection with FIG. 7 may assign the respective priority to each of the V2X devices in the first list.

At block 1606, the V2X device may measure at least one performance factor of the V2X device. In some examples, the performance factor may include one or more of a die temperature, a processor utilization percentage, a throughput, or a power consumption of the V2X device. For example, the measurement circuitry 742 shown and described above in connection with FIG. 7 may measure the performance factor(s).

At block 1608, the V2X device may select one or more the nearby V2X devices in the first list for inclusion in both the first list and a second list (or subset) based on the at least one performance factor and the respective priority of each of the nearby V2X devices. Each of the nearby V2X devices included in the second list may have a higher priority than the nearby V2X devices omitted from the second list. The number of V2X devices included in the second list may be determined, for example, based on the performance factor. For example, the flow control circuitry 743 shown and described above in connection with FIG. 7 may select the nearby V2X devices for inclusion in the second list.

At block 1610, the V2X device may control at least one characteristic related to the transmission and/or reception of V2X packets for nearby V2X devices included in the second list based on the performance factor(s). Examples of characteristics include, but are not limited to, the transmit power, transmit packet flow rate, type of packets allowed to be transmitted, and/or the modulation and coding scheme (MCS) and number of resource blocks assigned to transmit packets. For example, the flow control circuitry 743 together with the communication and processing circuitry 741 may control at least one characteristic of transmission and/or reception of V2X packets to and/or from nearby V2X devices included in the second list.

In one configuration, a first V2X device includes means for establishing a set of one or more nearby V2X devices capable of V2X communication with the first V2X device, means for assigning a respective priority to each of the one or more nearby V2X devices, means for identifying a subset of the set based, at least in part, on the assigned respective priorities and at least one performance factor of the first device, and means for limiting processing of packets received from the one or more nearby V2X devices to the packets received from the one or more nearby V2X devices in the subset.

In one aspect, the aforementioned means for establishing the set of one or more nearby V2X devices, means for assigning a respective priority to each of the one or more nearby V2X devices, means for identifying the subset of the set, and means for limiting processing of packets received from the one or more nearby V2X devices to the packets received from the one or more nearby V2X devices in the subset may be the processor(s) 704 shown in FIG. 7 configured to perform the functions recited by the aforementioned means. For example, the aforementioned means for establishing the set of one or more nearby V2X devices and the means for identifying the subset of the set may include the flow control circuitry 743 shown in FIG. 7. As another example, the aforementioned means for assigning the respective priority to each of the nearby V2X devices may include the priority assignment circuitry 744 shown in FIG. 7. As another example, the aforementioned means for limiting processing of the packets received from the one or more nearby V2X devices to the packets received from the one or more nearby V2X devices in the subset may include the flow control circuitry 743, together with the communication and processing circuitry 741 and transceiver 710, shown in FIG. 7. In another aspect, the aforementioned means may be a circuit or any apparatus configured to perform the functions recited by the aforementioned means.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-16 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 6, and/or 7 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method for vehicle-to-everything (V2X) wireless communication at a first V2X device, comprising:
establishing a set of one or more nearby V2X devices capable of V2X communication with the first V2X device;
assigning a respective priority to each of the one or more nearby V2X devices;
identifying a subset of the set based, at least in part, on the assigned respective priorities and at least one performance factor of the first device; and
limiting processing of packets received from the one or more nearby V2X devices to the packets received from the one or more nearby V2X devices in the subset.

2. The method of claim 1, wherein the at least one performance factor comprises one or more of a die temperature, a processor utilization percentage, a throughput, or a power consumption of the first V2X device.

3. The method of claim 1, wherein identifying the subset further comprises:
determining a number of the one or more nearby V2X devices for inclusion in the subset based on the at least one performance factor.

4. The method of claim 1, further comprising:
updating the respective priority of at least one of the one or more nearby V2X devices in the set.

5. The method of claim 4, wherein updating the respective priority further comprises:
updating the respective priority of the one or more nearby V2X devices included in the subset by receiving and processing the packets therefrom; and
adding to the subset at least one additional V2X device of the one or more nearby VX devices in the set that has remained outside of the subset for greater than a threshold duration to update the respective priority of the at least one additional V2X device by receiving and processing the packets therefrom.

6. The method of claim 5, wherein adding to the subset further comprises:
removing a first number of the one or more nearby V2X devices from the subset corresponding to a second number of the at least one additional V2X device added to the subset.

7. The method of claim 5, wherein the subset comprises a plurality of entries, and wherein adding to the subset further comprises:
reserving at least one entry of the plurality of entries for use in adding the at least one additional V2X device to the subset.

8. The method of claim 4, wherein updating the respective priority further comprises:
including a new V2X device in both the set and the subset to receive and process new packets from the new V2X device; and
assigning a new priority to the new V2X device based on device information related to the new V2X device obtained from the new packets.

9. The method of claim 1, wherein assigning the respective priority to each of the one or more nearby V2X devices further comprises:
processing the respective packets received from each of the one or more nearby V2X devices in the subset to obtain respective device information associated with each of the one or more nearby V2X devices in the subset; and
utilizing the respective device information to assign the respective priority to each of the one or more nearby V2X devices.

10. The method of claim 9, wherein the device information for each respective V2X device of the one or more nearby V2X devices comprises one or more of an indication of a priority of the respective V2X device, a periodicity of the packets received from the respective V2X device, a signal strength of the respective V2X device, or V2X data received from the respective V2X device.

11. The method of claim 10, wherein the V2X data of the respective V2X device comprises one or more of vision recognition information indicating a vision condition experienced by the respective V2X device, direction of travel of the respective V2X device, a location of the respective V2X device, a speed of the respective V2X device, an advanced driving assistance system indicator, or a basic safety message (BSM).

12. The method of claim 1, wherein identifying the subset of the set further comprises:
receiving control information in a subframe, wherein the control information indicates a first number of the packets received from the one or more nearby V2X devices included in the subframe;
determining a second number of the packets allowed to be decoded in the subframe based on the at least one performance factor; and
selecting less than all of the one or more nearby V2X devices in the set for inclusion in the subset when the first number of the packets is greater than the second number of the packets to reduce a receive packet flow rate;
wherein a number of the nearby V2X devices selected for inclusion in the subset is less than or equal to the second number of the packets.

13. The method of claim 12, wherein each of the one or more nearby V2X devices selected for inclusion in the subset transmitted one of the first number of the packets included in the subframe.

14. The method of claim 1, further comprising:
controlling at least one of a transmit power, a transmit packet flow rate, a type of transmit packets allowed to be transmitted, or both a modulation and coding scheme (MCS) and number of resource blocks selected for each of the transmit packets allowed to be transmitted based on the at least one performance factor.

15. The method of claim 1, wherein limiting processing of the packets received from the one or more nearby V2X devices to the packets received from the one or more nearby V2X devices in the subset further comprises:
preventing the first V2X device from decoding the packets received from the nearby V2X devices outside of the subset.

16. A first vehicle-to-everything (V2X) device for V2X wireless communication, comprising:
a processor;
a transceiver communicatively coupled to the processor; and
a memory communicatively coupled to the processor, wherein the processor is configured to:
establish a set of one or more nearby V2X devices capable of V2X communication with the first V2X device;
assign a respective priority to each of the one or more nearby V2X devices;
identify a subset of the set based, at least in part, on the assigned respective priorities and at least one performance factor of the first device; and
limit processing of packets received from the one or more nearby V2X devices to the packets received from the one or more nearby V2X devices in the subset.

17. The first V2X device of claim 16, wherein the at least one performance factor comprises one or more of a die temperature, a processor utilization percentage, a throughput, or a power consumption of the first V2X device.

18. The first V2X device of claim 16, wherein the processor is further configured to:
determine a number of the one or more nearby V2X devices for inclusion in the subset based on the at least one performance factor.

19. The first V2X device of claim 16, wherein the processor is further configured to:
update the respective priority of the one or more nearby V2X devices included in the subset by receiving and processing the packets therefrom;
add to the subset at least one additional V2X device of the one or more nearby VX devices in the set that has remained outside of the subset for greater than a threshold duration to update the respective priority of the at least one additional V2X device by receiving and processing the packets therefrom; and
remove a first number of the one or more nearby V2X devices from the subset corresponding to a second number of the at least one additional V2X device added to the subset.

20. The first V2X device of claim 16, wherein the subset comprises a plurality of entries, and wherein the processor is further configured to:
update the respective priority of the one or more nearby V2X devices included in the subset by receiving and processing the packets therefrom; and
reserve at least one entry of the plurality of entries for use in adding to the subset at least one additional V2X device of the one or more nearby VX devices in the set that has remained outside of the subset for greater than a threshold duration to update the respective priority of the at least one additional V2X device by receiving and processing the packets therefrom.

21. The V2X device of claim 16, wherein the processor is further configured to:
process the respective packets received from each of the one or more nearby V2X devices in the subset to obtain respective device information associated with each of the one or more nearby V2X devices in the subset; and
utilize the respective device information to assign the respective priority to each of the one or more nearby V2X devices in the subset, wherein the device information for each respective V2X device of the one or more nearby V2X devices comprises one or more of an indication of a priority of the respective V2X device, a periodicity of the packets received from the respective V2X device, a signal strength of the respective V2X device, or V2X data received from the respective V2X device.

22. The first V2X device of claim 21, wherein the V2X data of the respective V2X device comprises one or more of vision recognition information indicating a vision condition experienced by the respective V2X device, direction of travel of the respective V2X device, a location of the respective V2X device, a speed of the respective V2X device, an advanced driving assistance system indicator, or a basic safety message (BSM).

23. The first V2X device of claim 16, wherein the processor is further configured to:
receive control information in a subframe, wherein the control information indicates a first number of the packets received from the one or more nearby V2X devices included in the subframe;
determine a second number of the packets allowed to be decoded in the subframe based on the at least one performance factor; and
select less than all of the one or more nearby V2X devices in the set for inclusion in the subset when the first number of the packets is greater than the second number of the packets to reduce a receive packet flow rate;
wherein a number of the one or more nearby V2X devices selected for inclusion in the subset is less than or equal to the second number of the packets.

24. The first V2X device of claim 23, wherein each of the nearby V2X devices selected for inclusion in the subset transmitted one of the first number of the packets included in the subframe.

25. The first V2X device of claim 16, wherein the processor is further configured to:
control at least one of a transmit power, a transmit packet flow rate, a type of transmit packets allowed to be transmitted, or both a modulation and coding scheme (MCS) and number of resource blocks selected for each of the transmit packets allowed to be transmitted based on the at least one performance factor.

26. A first cellular vehicle-to-everything (V2X) device for V2X wireless communication, comprising:
means for establishing a set of one or more nearby V2X devices capable of V2X communication with the first V2X device;
means for assigning a respective priority to each of the one or more nearby V2X devices;
means for identifying a subset of the set based, at least in part, on the assigned respective priorities and at least one performance factor of the first device; and
means for limiting processing of packets received from the one or more nearby V2X devices to the packets received from the one or more nearby V2X devices in the subset.

27. The first V2X device of claim 26, wherein the means for identifying the subset of the set further comprises:
means for determining a number of the one or more nearby V2X devices selected for inclusion in the subset based on the at least one performance factor.

28. The first V2X device of claim 26, further comprising:
means for updating the respective priority of the one or more nearby V2X devices included in the subset by receiving and processing the packets therefrom;
means for adding to the subset at least one additional V2X device of the one or more nearby VX devices in the set that has remained outside of the subset for greater than a threshold duration to update the respective priority of the at least one additional V2X device by receiving and processing the packets therefrom; and
means for removing a first number of the one or more nearby V2X devices from the subset corresponding to a second number of the at least one additional V2X device added to the subset.

29. The first V2X device of claim 26, wherein the subset comprises a plurality of entries, and further comprising:
means for updating the respective priority of the one or more nearby V2X devices included in the subset by receiving and processing the packets therefrom; and
means for reserving at least one entry of the plurality of entries for use in adding to the subset at least one additional V2X device of the one or more nearby VX devices in the set that has remained outside of the subset for greater than a threshold duration to update the respective priority of the at least one additional V2X device by receiving and processing the packets therefrom.

30. The first V2X device of claim 26, further comprising:
means for receiving control information in a subframe, wherein the control information indicates a first number of the packets received from the one or more nearby V2X devices included in the subframe;
means for determining a second number of the packets allowed to be decoded in the subframe based on the at least one performance factor; and
means for selecting less than all of the one or more nearby V2X devices in the set for inclusion in the subset when the first number of the packets is greater than the second number of the packets to reduce a receive packet flow rate;
wherein a number of the one or more nearby V2X devices selected for inclusion in the subset is less than or equal to the second number of the packets.
